(19) United States
(12) Patent Application Publication
(10) Pub. No.: US 2026/0338911 A1
(43) Pub. Date: Oct. 29, 2026

(54) SYSTEMS AND METHODS FOR INTERFERENCE REDUCTION

(71) Applicants: MOHAMMED VAHID DANESH-BAHREINI, BELLEVUE, WA (US); KAVEH DANESH, SAN FRANSISCO, CA (US); BAHAREH DANESH-BAHREINI, KIRKLAND, WA (US)

(72) Inventors: MOHAMMED VAHID DANESH-BAHREINI, BELLEVUE, WA (US); KAVEH DANESH, SAN FRANSISCO, CA (US); BAHAREH DANESH-BAHREINI, KIRKLAND, WA (US)

(21) Appl. No.: 18/996,659

(22) PCT Filed: Jul. 21, 2022
(86) PCT No.: PCT/US22/73990

§ 371 Date: Jan. 17, 2025

(51) Int. Cl. G01S 7/02; H04W 52/24

(52) U.S. Cl. CPC G01S 7/023; H04W 52/242; H04W 52/243

(57) ABSTRACT

In certain configurations, the present disclosure relates to a method for reducing interference between a first transmitter-receiver unit and a second transmitter-receiver unit. The method may comprise: detecting, at the second transmitter-receiver unit, a first radio transmission. Based on the detection of the first radio transmission, the method may include determining an interference level between the first transmitter-receiver unit and the second transmitter-receiver unit. Based on the determined interference level between the first transmitter-receiver unit and the second transmitter-receiver unit, the method may include employing one or more interference reduction techniques, selected from: reducing the power of the transmission of the second transmitter-receiver unit; altering the angle at which the transmission of the second transmitter-receiver unit is emitted; and halting the transmission at the second transmitter-receiver unit.

### PRIORITY CLAIM

This application is a National Phase Application filed under 35 U.S.C. § 371 as a national stage of PCT/US22/73990, filed on Jul. 21, 2022, which is incorporated by reference in its entirety.

### BACKGROUND

### Field

The present disclosure generally relates to techniques and methods for reducing interference at a receiver.

### Background

Major telecom companies, cellular carriers, and other entities have made significant investments improving cellular networks in the US and abroad. Many of these investments have included upgrading the cellular networks to take advantage of newer transmission technologies, such as 5G network transmission. 5G networks have several significant advantages over past cellular technologies, including improved capacity, user limits, and bandwidth. These improvements are made possible in part by operating in a new spectrum including the C-band.

More specifically, wireless carriers have purchased segments of C-band frequencies to be utilized for 5G network in high traffic venues to take advantage of this extended coverage and capacity. Some of the frequency ranges purchased include the ranges between 3.7 GHz and 3.98 GHz. These C-band frequency ranges are directly adjacent to a common frequency range utilized by aircraft low range radio altimeters (LRRA), For instance, The National Telecommunications and Information Administration (NTIA) has indicated that the 4.2 GHz-4.4 GHz band is a shared band internationally reserved for low range radio altimeters installed on aircraft.

LRRA's are a necessary piece of equipment in modern aviation. LRRA antennas are installed at the bottom of airplanes, helicopters, and similar aircraft including both transmit and receive antennas. When approaching an airport for landing, these antennas transmit a signal, typically through either a pulse or continuous wave, that is reflected off the ground and is received by the LRRA receiving antennas. After the reflected wave is received, an algorithm uses the difference timing of these signals to accurately provide the radar height of the airplane above ground level (AGL).

In an attempt to ensure there is no interference between the two systems, the Federal Communication Commission (FCC) established about 0.22 GHz or 220 MHz of guard band frequency between the adjacent 5G and LRRA bands, Nevertheless, it has been determined by the Federal Aviation Administration (FAA) that the two adjacent bands, the LRRA band 4.2 GHz-4.4 GHz and 5G C-band 3.7 GHz-3.98 GHz, can interfere in spite of the 220 MHz of guard band assigned by the FCC between the two.

As the situation stands, cellular carriers have invested in upgrading and improving the cellular networks across the country, including near airports and other high traffic venues to take advantage of 5G C-band technology. These upgraded 5G towers transmit signals that have the potential to interfere with airplane radio altimeters, causing potentially catastrophic problems for airplanes, especially in low visibility conditions.

### SUMMARY

Disclosed herein are systems, techniques, and methods for interference reduction. In various configurations, the present disclosure relates to systems, techniques, and methods for reducing interference between one transmitter/receiver unit and a second transmitter-receiver unit, such as between an aircraft's LRRA system and a 5G C-band transmission site.

In certain configurations, the present disclosure relates to a method for reducing interference between a first transmitter-receiver unit and a second transmitter-receiver unit. The method may comprise: detecting, at the second transmitter-receiver unit, a first radio transmission. Based on the detection of the first radio transmission, the method may include determining an interference level between the first transmitter-receiver unit and the second transmitter-receiver unit. Based on the determined interference level between the first transmitter-receiver unit and the second transmitter-receiver unit, the method may include employing one or more interference reduction techniques, selected from: reducing the power of the transmission of the second transmitter-receiver unit; altering the angle at which the transmission of the second transmitter-receiver unit is emitted; and halting the transmission at the second transmitter-receiver unit.

In some specific implementations of the present systems, techniques, and methods, the first transmitter-receiver unit may be an aircraft low range radio altimeter, and the second transmitter-receiver unit may be a 5G C-band transmission site. Likewise, the first radio transmission detected at the 5G C-Band transmission site may be an aircraft low range radio altimeter transmission having a frequency ranging from about 3.85 GHz to about 4.4 GHz. In the same or different configuration, detecting the aircraft low range radio altimeter transmission having a frequency ranging from about 3.75 GHz to about 4.4 GHz includes identifying the presence of at least one out of band emission ranging from about 3.85 GHz to about 4.0 GHz.

The systems and methods disclosed herein may also relate to determining that the interference level exceeds a certain threshold. In some embodiments, determining that the interference level exceeds a certain threshold may comprise: measuring the magnitude of the received aircraft low range radio altimeter transmission; calculating a path loss of the low range radio altimeter transmission based on the measured magnitude of the received signal and a known estimate for the transmission power of aircraft altimeters; estimating the proximity of the aircraft based on the calculated pathloss of the signal; calculating the pathloss of the 5G transmission based on the known transmission power and transmission angle of the 5G signal to estimate the magnitude of the 5G transmission received at the aircraft; and determining that the magnitude of the 5G transmission received at the aircraft exceeds a defined threshold. In some configurations the known estimate for the transmission power of aircraft altimeters ranges from between about 0.5 Watts (or about 27 dBm) to about 5.0 Watts (or about 37 dBm)—although each OEM may choose different power levels as permitted by the National Telecommunications and Information Administration (NTIA). The transmission power of the largest 5G MIMO array may be about 120 Watts (or about 51 dBm). Likewise, reducing the power of the transmission of the second transmitter-receiver unit may include one or more iterative steps of: attenuating the transmission power by increments of 2 Watts; and altering the angle at which the transmission of the second transmitter-receiver unit is emitted includes implementing a down tilt of about 3 degrees. In some configurations, down tilt may be preferable to powering down since a down title does not affect capacity has much as a power reduction may.

In some embodiments of the present disclosure, halting the transmission at the second transmitter-receiver unit is applied after determining that attenuating the transmission power or altering the angle at which the transmission of the second transmitter-receiver unit is emitted cannot bring the interference level below the defined threshold based on the estimated proximity of the aircraft. Likewise, in some configurations the defined threshold is about 0 dBm.

In still further configurations, the systems, techniques, and methods may further comprise determining a risk of interference by obtaining corroborating data from one or more datasets. The corroborating data may include: weather data; visibility data; runway condition data; air traffic control data; the aircraft identification information; and past interference mitigation events.

In various configurations, the present disclosure relates to a system for reducing interference between aircraft low range radio altimeter and a 5G transmission site. The system may comprise the 5G transmission site configured to include an antenna communicatively coupled with at least one of a frequency power detector, Root Mean Square (RMS) detector or Envelop detector configured to identify the presence of an aircraft low range radio altimeter transmission; a baseband unit communicatively coupled with the frequency power detector, RMS detector or Envelop detector, wherein the baseband unit is configured to control properties of the signal emitted from the 5G transmission site where the properties may include down tilt and transmission power level; an operational support system, communicatively coupled with the baseband unit and configured to interface with one or more databases containing data relating to: weather; visibility; runway conditions; air traffic; and memory containing instructions corresponding to an algorithm that when executed by a processor cause the system to cause the baseband unit to employ one or more interference reduction techniques. The interference reduction techniques may be selected from: reducing the power of the 5G transmission; altering the angle at which the 5G transmission is emitted; and halting the 5G transmission for a period of time.

In some configurations of the disclosed system, the algorithm further includes the step of determining that an interference level between the aircraft low range radio altimeter and the 5G transmission site exceeds a defined threshold by calculating the pathloss of the signal of interest based on the magnitude of the received aircraft low range radio altimeter transmission at a distance and using a known estimate for the transmission power of the low range radio altimeter transmission; and measuring the magnitude of the received aircraft low range radio altimeter transmission. The algorithm may be further configured to calculate a path loss of the low range radio altimeter transmission based on the measured magnitude of the received signal and a known estimate for the transmission power of aircraft altimeters. Similarly, the algorithm may be configured to estimate the proximity of the aircraft based on the calculated pathloss of the signal and to calculate the pathloss of the 5G transmission based on the known transmission power and transmission angle of the 5G signal to estimate the magnitude of the 5G transmission received at the aircraft. Based on the foregoing, the algorithm may determine that the magnitude of the 5G transmission received at the aircraft exceeds a defined threshold.

In various configurations, the system can be configured to iteratively apply the one or more interference reduction techniques until the adjusted interference level no longer exceeds the defined threshold, or to cease transmission at the 5G transmission site if other interference reduction techniques are not estimated to reduce the interference level below the defined threshold. In still further configurations the one or more interference reduction techniques may be selected based upon the determined interference level between the aircraft radio altimeter and the 5G transmission site,

Some configurations of the disclosed system utilize additional components. For instance, in some configurations of the disclosed system the antenna is communicatively coupled with an ultra low noise amplifier as a preamp configured to amplify at least a portion of the signal of interest; the amplifier is communicatively coupled with a band pass filter; the band pass filter is communicatively coupled with the power detector, RMS detector, or Envelop detector; which can be communicatively coupled with a voltage comparator; the voltage comparator is communicatively coupled with an existing alarm box associated with the 5G transmission site; and the alarm box is communicatively coupled with the existing base band unit. In some of these configurations, the band pass filter may be configured with a passband of about 4070 MHz to about 4190 MHz.

The present disclosure may also relate to other systems for reducing interference between an aircraft low range radio altimeter and a 5G transmission site. In some embodiments the systems may comprise an antenna which may be an external omni directional antenna configured to receive signals having a frequency ranging from about 3.9 GHz to about 4.7 GHZ, The antenna may be communicatively coupled with a low noise splitter configured to split the received signal into two or more signals; and the splitter communicatively coupled with one or more ultra low noise amplifiers, the amplifiers configured to amplify the received and split signal. Likewise, the two or more amplifiers communicatively coupled with one or more band pass filters configured with distinct, non-overlapping passbands where the two or more band pass filters configured with distinct, non-overlapping passbands are communicatively coupled with one or more fast reacting logarithmic power detectors. The one or more fast reacting logarithmic power detectors may be communicatively coupled with at least one differential low noise amplifier configured to amplify the difference in voltage generated between the two or more band pass filters; and the at least one differential low noise amplifier may be communicatively coupled with at least one voltage comparator configured to identify the presence of a suspected low range radio altimeter signal based on the voltage difference generated by the differential voltage comparator. Some of the proposed embodiment may use existing EVAL Circuit Boards with chips such as ADA4625-1 differential op amp and ADL551 Envelop detector and TruRMS Pulse detector in various proposed detection methods. One voltage comparator may be in turn communicatively coupled with a 2-10 minutes timer communicatively coupled with existing 5G alarm box communicatively coupled with existing base band unit disposed at the 5G transmission site which may be communicatively coupled with one or more operational support systems. The Base band unit can be programmed to react to a 1 volt signal of interference and 0 volt signal of no interference. If a 1 volt interference is received then it communicate with operation system software (SON) to pull updates on weather, ADS-B, or other data before determining whether to power down, tilt down, or power off, for example on low visibility days.

In some embodiments, the interference reduction countermeasures are selected from the group comprising: reducing the power of the transmission of the second transmitter-receiver unit; altering the angle at which the transmission of the second transmitter-receiver unit is emitted; and halting the transmission at the second transmitter-receiver unit.

In some of these configurations, the antenna is an antenna external to the 5G transmission site. Likewise, in certain configurations the two band pass filters are configured to cancel a persistent but variable noise floor having a frequency ranging from about 4.445 GHZ to about 4.555 GHz. Noise floor testing was performed using a spectrum analyzer with an omnidirectional antenna during early morning hours between 1 AM and 4 AM PT (when there were no airplanes flying in the vicinity of the Seattle Tacoma airport in Washington state, USA) to establish the noise floor. This same noise floor was observed during daytime when airplane pulses were observed. The noise floor amplitude was observed to be consistent at an average of −81 dBm amplitude across all frequency bands of 3,980 GHZ to 4.600 GHZ and the only variation in amplitude was +/−1 dBm (a range −80 to −82 dBm amplitude). Accordingly, when a pulse of 2 dBm from a LRRA (that is susceptible to 5G interference) appears, it is expected to observe a 2 dBm (or more) amplitude increase due to the pulse. This 2 dBm or greater pulse can trigger a voltage signal to request the BBU power down, tilt down, or power off. This 2 dBm pulse may be the minimum value detectable, but as the aircraft approaches the amplitude can increase, in some cases up to a maximum of about 20 dBm when the aircraft is over head. Some of these configurations include a first band pass filter having a passband of about 4.445 GHz to 4.555 GHz; and a second band pass filter having a passband of about 4.035 GHz to about 4.135 GHz. In other configurations using an ADL5511 chip (discussed in detail below) only one Band pass filter in the common interference range of 4.035 GHz-4.135 GHz was used as the ADL511 could be configured to react to envelop and RMS pulses and therefore no cancelation of the noise floor of-81 dBm was needed.

### BRIEF DESCRIPTION OF DRAWINGS

Various embodiments are depicted in the accompanying drawings for illustrative purposes and should in no way be interpreted as limiting the scope of the embodiments. Various features of different disclosed embodiments can be combined to form additional embodiments, which are part of this disclosure.

FIG. 1 presents a schematic view of an integrated 5G radio and antenna system configured to reduce interference in accordance with the present embodiment.

FIG. 2 presents a schematic view of an embodiment of an external antenna system configured to interface with a 5G transmission site in accordance with the present disclosure.

FIG. 3 presents a schematic view of another embodiment of external antenna system configured to interface with a 5G transmission site in accordance with the present disclosure.

FIGS. 4A-D present a schematic view of a various embodiments of alarm light configurations for the systems disclosed herein.

FIG. 5 presents a schematic view of an embodiment of a power supply connection configured to interface with the presently disclosed systems.

FIG. 6 displays the standing wave and VSWR test results of a first antenna tested for use in accordance with the present disclosure.

FIG. 7 displays test results showing the directionality of a first antenna tested for use in accordance with the present disclosure,

FIG. 8 displays the standing wave and VSWR test results of a second antenna tested for use in accordance with the present disclosure.

FIG. 9 displays test results showing the directionality of a second antenna tested for use in accordance with the present disclosure.

FIG. 10 depicts an experimental equipment set up configured to measure aircraft low range altimeter signals received at certain location.

FIG. 11 presents a schematic view of an embodiment of an antenna system configured to interface with a 5G transmission site in accordance with the present disclosure.

FIG. 12 presents a schematic view of an embodiment of an antenna system configured to interface with a 5G transmission site in accordance with the present disclosure.

FIG. 13 presents a schematic view of an embodiment of an antenna system configured to interface with a 5G transmission site in accordance with the present disclosure.

### DETAILED DESCRIPTION INCLUDING PREFERRED EMBODIMENT

Various systems and methods relating to systems and methods for reducing interference are described below to illustrate selected examples that may achieve one or more desired improvements. These examples are only illustrative and not intended in any way to restrict the general disclosure presented or the various aspects and features described herein. Furthermore, the general principles described herein may be applied to embodiments and applications other than those specifically discussed herein without departing from the spirit and scope of the disclosure. This disclosure is not limited to any particular embodiment shown but is instead to be accorded the widest scope consistent with the principles and features that are disclosed or suggested.

### Overview

In many modern aircraft, LRRA systems are critical to safe operations during low altitude flight conditions and can be critical to select instrument landing systems used during low visibility conditions. However, the receiver of various LRRA systems can be subject to interference with various other transmissions, such as 5G C-band transmissions. In the event of interference, the LRRA system can provide erroneous AGL readings to the pilot or aircraft systems, or the LRRA can cease to function entirely.

The present disclosure provides a review of both systems: LRRA and 5G C-band operations to provide a solution that accurately, cost effectively, and efficiently resolves the 5G C-band interference with LRRA functionality to allow for the safe coexistence between the two systems while meeting FAA safety standards. However, the systems and methods disclosed herein can be similarly used to resolve interference between various other types of transmitters and receivers as well.

In some embodiments, the systems and methods disclosed herein can be utilized to reduce interference in a system comprising at least two transmitter/receiver sources. For instance, in some embodiments the presently disclosed systems and methods may relate to the detection of a signal transmitted by a first transmission source at a second transmission source, Based at least in part on the detection of the first transmission signal, the system can be configured to implement one or more interference reduction countermeasures at the second transmission source to reduce or eliminate interference at the first transmitter/receiver caused by emissions from the second transmission source. Some interference reduction countermeasures may include adjusting the angle at which the second signal is transmitted, reducing the power at which the second signal is transmitted, or ceasing the second transmission entirely. In some configurations, the selection of the interference reduction countermeasures is informed by characteristics of the first signal, the characteristics of the first transmission source, the at least approximate position of at least one of the transmitter/receivers, or other conditions such as ambient weather conditions to improve the functionality of the system.

More specifically, in some embodiments the present disclosure relates to systems and methods for reducing 5G signal interference at aircraft altimeter systems. As such, in some embodiments the present disclosure relates to detecting a first transmission, such as an LRRA signal, and based at least in part on the detection of the first signal employing one or more interference reduction countermeasures. Some of the interference reduction countermeasures disclosed herein include adjusting the tilt of the 5G signal transmission, reducing the power at which the 5G signal is transmitted, or shutting down the 5G signal transmitter. In some configurations, the systems and methods disclosed herein may involve determining a potential for interference, and the one or more interference reduction countermeasures may be selected based on that determination. In this manner, any interference caused by the 5G system on the LRRA that could cause erroneous altitude determination by the LRRA system can be reduced or eliminated.

In some configurations, the systems can be augmented with data obtained from various aviation or meteorological sources such as Air Traffic Control (ATC) services, Automatic Dependent Surveillance-Broadcast (ADS-B) information, or meteorological information/forecast to confirm, corroborate, or alter the interference countermeasure decision. Likewise, the interference reduction countermeasures selected may be informed by the measured or otherwise determined at least approximate position of the first transmission source or the first transmission signal, for example by measuring the received signal strength and at least estimating the pathloss of the first transmission signal.

Various embodiments of suitable systems configured to achieve the described functionality are disclosed herein. In some embodiments the systems disclosed herein can easily and effectively integrate with existing 5G C-band nodes and may only require minor software and/or hardware changes to a 5G C-band system. In the same or different embodiment, the systems disclosed herein may require no hardware changes to the 5G C-band system or can include redundancy measures to meet FAA standards.

For example, in some embodiments, the present disclosure relates to systems and methods that can utilize hardware already existing on 5G C-band cell towers to reduce or eliminate interference. In the same or different embodiments, the systems may utilize an external antenna for certain functions, such as to detect LRRA transmissions. Regardless of the configuration, any of these systems, techniques, and methods may be employed not only in vicinity of the low visibility airports but at other 5G cell tower location. Similarly, such systems may be used prior to the installation of a 5G cell tower or prior to making a 5G cell tower operational to determine the need for transmission, mitigation, or interference reduction countermeasure, or to determine optimal working transmission settings (e.g., tilt, power, transmission time) to be used based on expected aircraft traffic parameters.

### Various System Components

Disclosed herein is a system that can be easily installed, is cost effective to implement, and simple to integrate with existing systems. In some embodiments, the system may include a circuit configured to interface with an antenna, one or more band pass filters, a logarithmic power detector, a logarithmic power differential, and a power to voltage converter to signal the 5G C-band transmission system to employ an interference reduction countermeasure. In various configurations, the logarithmic power detector is sensitive enough to detect ether frequency modulated continuous wave radar (FMCW) transmissions or pulse transmissions commonly utilized by LRRA systems.

In various embodiments, the system utilizes the one or more customized band pass filters to detect transmissions within a common range to aircraft that has a potential to receive 5G transmission that may interfere with LRRA functionality.

Likewise, the system can be configured to ignore aircraft with little to no potential for interference that could otherwise result in the unnecessary deployment of interference reduction countermeasures. For example, in some embodiments the system can be configured to detect transmissions occurring in the frequency band of about 4035-4135 MHz that may be associated with LRRA transmissions from aircraft that are susceptible to 5G C-band interference issues.

The systems disclosed herein can be configured to interface with ATC services, ADS-B information, meteorological information/forecast, or other similar data sources as a verification tool, such as to prevent the unnecessary deployment of interference reduction countermeasures when conditions do not indicate that such countermeasures are needed, such as on non-low visibility days or days with dry uncontaminated runways,

In some configurations the system utilizes an algorithm that may be implemented to make the system more intelligent. For example, interference mitigation techniques can be based on, or informed by, characteristics of the detected signal or signal source, whether measured or otherwise obtained, such as LRRA path loss calculations, LRRA position (such as lateral distance or altitude), aircraft make and model (e.g., obtained from ATC), the frequency of the detected signal, and others.

Suitable algorithms can also be configured to learn over time. For example, the system can be configured to retain data concerning previously employed interference reduction countermeasures in order to update future mitigation decisions, whether through data table look up methods, machine learning, or other suitable systems. In some configurations the algorithm can help ensure the system meets the stringent safety requirements set forth by the FAA. Likewise, in some configurations, the systems disclosed herein can be equipped to generate an alarm in the event that an error condition or other failure is detected.

### Radio Altimeters

It is important to provide an accurate height above ground level (AGL) to pilots or aircraft systems for safe landing. These readings are especially critical in low visibility conditions where aircraft systems or a pilot may become heavily reliant on accurate AGL instrumentation, making the aircraft's low range radio altimeter a key.

A radio altimeter system generally comprises receiving and transmitting antennas communicatively coupled with a processor and a pilot display in the cockpit. Most low range radio altimeter systems transmit signals to the earth's surface through the transmitting antenna. These signals traverse through the air and are reflected off the ground, where they bounce back towards the aircraft where the reflected signals can be received by the receiving antenna. Many radio altimeters transmit and receive the signal in one of two ways,

First, some radio altimeters utilize frequency modulated continuous wave (FMCW) emissions. These continuous wave radar systems linearly or pseudo-randomly “chirp” or frequency modulate their transmitters rapidly enough to avoid self-interference with returns from objects beyond some minimum distance. In this manner, this type of radar can detect and range static targets. This approach is commonly used in radio altimeters.

One example of a frequency modulated continuous wave radio altimeter system includes a system that transmits a signal that ramps up and down over time between a minimum and maximum frequency (e.g., between about 4345 MHz and about 4355 MHz as observed during field testing utilizing a spectrum analyzer). Because the signal takes some time to reach the ground and return to the aircraft, the frequency of the received signal is delayed relative to the signal that is broadcast. The difference between the two frequencies can be extracted in the radio altimeter's frequency mixer and coupled with the known speed of light the processor can determine a distance or height above ground level reading which can be displayed in the cockpit and fed to other aircraft systems. Other radio altimeter systems utilize a pulse transmission pattern. These systems transmit short signal pulses and measure the time it takes the signal to travel to the ground and reflect back to the aircraft. Generally, these pulse generator LRRA's commonly transmit in 4035-4135 MHZ band in addition to other frequencies. Some LRRA's are subject to out of band emissions. Out of band emissions occur when a first transmitter transmits to an adjacent band occupied by a second transmitter. Presently there is 220 MHZ of guard band between the allotted LRRA and 5G C-band frequencies, so much of the 5G C-band interference at the LRRA is assumed to be a co-channel interference where the LRRA transmits outside of its assigned 4.2 to 4.4 GHZ band and transmits in the 220 MHZ guard band, and may transmit pulses down to 3.75 GHZ.

A band pass filter installed on the LRRA system (on the aircraft) may not solve the interference problem caused by co-channel interference when dealing with fast-moving aircraft. Because different LRRA's by various OEM's transmit pulses in different frequencies, some even as low as about 3.8 GHZ (which is in the 5G C-band) a band pass filters installed at the LRRA transmitter receiver unit may block many transmit and receive pulses by the LRRA that is needed for accurate operation. This group of airplanes susceptible to co-channel interference presents a more serious problem than simple out of band emission issues. Out of band emissions being received from another transmitter may be resolved using band pass filters at the receiver of the LRRA. But, based on field testing using a spectrum analyzer, initial pulses from some LRRAs may be transmitted at around 4300 MHz but as the LRRA continues sending pulses over time, many pulses were being sent at lower frequencies (e.g., all the way down to 3.8 GHZ which is in the 5G C-band). Accordingly, use of a band pass filter at or in the LRRA system may degrade the efficient and accurate operations of the LRRA. For example, airplanes approaching airports at around 1000 ft AGL at a speed of 185 knots per hour on a three degree glide path may experience degraded LRRA operation if many of the pulse transmissions being generated within the LRRA are in the band being blocked by the band pass filter installed at or in the LRRA.

TABLE 1
TYPICAL PERFORMANCE CHARACTERISTICS

| Parameter | Civil/Commercial |
|---|---|
| Maximum Reported Altitude | 2,500-7,500 ft |
| Altitude Accuracy | ±1.5 ft to ±3 ft up to 100 ft AGL |
| | ±2% to ±3% from 100 to 500 ft AGL |
| | ±2% to ±5% above 500 ft AGL |
| Aircraft Pitch and Roll Angles | ±20° to ±40° |
| Antenna Peak Gain at 4.3 GHz | 7-13 dBi (common 10-11 dBi) |
| Bandwidth at 4.3 GHz | +/−20 degrees to +/−45 degrees. |
| Transmit PWER | 1-4 watts depending on vendor |

Manufacturers of LRRA include Aaronia AG; EIT Avionics; FreeFlight Systems; HONEYWELL; Servicios de Radio Wavenet, S.L.; and Shanghai TopXGun Robotics Co., Ltd.

### 5G Transmitters

Many cellular networks have been upgraded to take advantage of 5G wireless technology. These 5G networks utilize higher frequency ranges, such as the C-band which can range between about 3.7 GHZ and 3.98 GHz. However, use of higher frequency ranges, as compared to lower frequency cellular networks, comes with some disadvantages. For instance, these higher frequency ranges make multi-antenna systems necessary because higher frequencies do not propagate as well as lower frequencies. Multi-antenna systems and beamforming can partially mitigate these effects.

Beamforming is an active antenna technology that uses directional radio links to supply individual mobile devices simultaneously and selectively with high bandwidth. Beamforming enables the spatially targeted transmission and reception of radio signals. The more antenna elements (or dipoles—there can be up to 128 dipoles in 5G smart antennas produced by various manufacturers) that are available, the better beamforming capability of the system can be. Accordingly, beamforming is an excellent solution for multi-antennae arrays. These arrays of extremely small antennas with high directivity can provide individual mobile devices with a high transmission rate. In the latest 3D Multiple-Input Multiple-Output (MIMO) and massive MIMO devices, several transmitter and receiver units are in one terminal device.

5G New Radio (NR) infrastructure has been built to take advantage of these multi-antennae arrays. These active arrays provide the necessary functionality to enable multi-user MIMO technologies. These antenna modules use beamforming for targeted radio contact with the receiver to improve signal quality, connectivity, and bandwidth.

### Interference and Interference Reduction

There are two main mechanisms of interest through which C-band transmissions may interfere with altimeter functionality. The first is desensitization, which can also be referred to as receiver blocking. In this mechanism, a radio receiver may be unable or less able to receive a radio signal that it might otherwise be able to receive when there is no interference. This can be caused by a nearby transmitter with a strong signal on a close frequency, which overloads the receiver and makes it unable to fully receive the desired signal.

A second mechanism of interference includes out of band and spurious emissions. Out of band emissions are unwanted emissions immediately outside the assigned channel bandwidth resulting from the modulation process and non-linearity in the transmitter. In some cases, this scenario can be less likely due to the 220 MHz guard band between C-band and altimeter frequencies. However, in scenarios where selected LRRA may transmits and receives in 5G C-band, this mode of interference may become more of a concern.

Interference can be mitigated by re-orienting the beam of the transmission through tilt, reducing the power of the transmission, or by ceasing the transmission altogether.

Tilt represents inclination or angel of antenna radiation. A down tilt is when the antenna pattern is electronically shifted downwardly. For 5G C-band transmitters, electrical tilts are generally down tilts that typically can be adjusted from about zero degrees (aligned with the horizon) to about 14 degrees down. Tilting down will generally shrink the coverage but not the capacity of the 5G transmission site.

Conversely, the power at which the signal is transmitted affects the coverage of an affected area, but also can have pronounced effects on network capacity. As such, when choosing signal interference mitigation techniques, many wireless carries may prefer tilt down over reducing transmission power when feasible.

### Detection of LRRA

The system can be configured to monitor for the presence of radio altimeter signals, and only employ an interference mitigation technique in the event that a radio altimeter has been detected or in the event that a radio altimeter has been detected on a low visibility day.

Because the 5G remote radio head (RRH) sensitivity is very high, it is thought that the RRH may be able to detect a LRRA (which may be about 100 times or 20 dB weaker than the 5G signal) before the SG signal begins to interfere with the LRRA's operation.

An alarm can be triggered when the system detects a signal in the operating band assigned to LRRA, a signal within the guard band between the 5G C-band and LRAA band, or a signal otherwise associated with a LRRA. In some embodiments, the alarm will only be triggered when the system detects a signal associated with a LRRA having selected characteristics. For example, in some embodiments, the system can be configured to monitor specifically for transmissions in the guard band or C-band frequencies to detect aircraft that may be particularly susceptible to 5G C-band interference. In other embodiments, the system may use pathloss calculation to determine the proximity of the LRRA to determine whether to trigger and alert or the type of interference mitigation technique to be employed. In some cases, selected LRRA may not be susceptible to 5G interference or 5G interference may only be a concern under selected circumstances. Accordingly, in yet other embodiments, supplemental data may be used to determine whether to trigger an alert or the type of interference mitigation technique to employ.

Once such a signal is detected, the system can be configured to employ one or more interference reduction countermeasures. For example, the system can be configured to control the remote radio head (RRH) or to communicate with the gNodeB (gNB) or the base band unit (BBU) to employ certain interference reduction countermeasures such as adjusting the tilt of the transmission, reducing the power of the transmission, or halting the transmission entirely. Advantageously, the BBU can be configured to implement such changes in a relatively short span of time ranging from minutes to seconds after detection.

The specific interference reduction countermeasure, or a combination of countermeasures, may be determined and employed dynamically by an algorithm. The algorithm can be configured to be updated regularly, such as every few hours. The algorithm may be informed by other data elements including weather information/forecast, runway condition (e.g., contaminated or wet runway conditions), air traffic control information, ADS-B information/position, FAA/regulatory authority data, airport information, Flight Aware information, flight plan information (e.g., aircraft type and identification), known proximity to airports, air traffic maps, calculated pathloss, previous altimeter alert patterns, or other data elements.

These mitigation techniques can be stored in the gNb in form of parameters. If the algorithm has not updated the mitigation techniques in a predetermined period of time, such as a period of minutes or hours, then the BBU may be configured to implement the safest or most aggressive interference reduction countermeasure or combination of countermeasures, such as locking the remote radio head in response to detecting a suspected altimeter signal. In selected embodiments, the interference mitigation techniques for various conditions or scenarios may be agreed to or pre-approved by regulatory authorities, such as the FAA.

### Self-Organizing Network (SON) Algorithm

In some embodiments, the systems and methods disclosed herein include the installation of an external antenna next to each 5G antennas on 5G towers. Other embodiments may utilize existing or modified 5G antennas with expanded receipt bands having a range of about 3.7 to 4.4 GHz within proximity of airports. These antennas can be configured to collect data on the signals transmitted by radio altimeters. Regardless of the specific implementation, this data can then be feed into an algorithm, such as a SON algorithm detailed below, which can automatically employ an interference reduction countermeasure at the 5G tower upon detection of a LRRA signal so that the 5G tower no longer interferes with the detected LRRA. In some cases, the existing 5G system software may be modified to perform this function.

One goal of the algorithm is to use data relating to the signal received at or near the 5G tower from a source such as a low range radio altimeter to determine when the 5G tower can safely transmit signals, and what at what power it can safely do so. For example, a single antenna A may be built next to a 5G tower and record whether a signal S is received. In some relatively simple configurations, the system can be configured to power off the 5G transmission at the tower when A observes a signal S. In some embodiments, the transmission may be halted for a number of seconds or a period K ranging from about 2 to 10 minutes after the signal S is detected.

A more elaborate algorithm can be configured to set the 5G to a certain level of power. For example, when a signal S is detected, the system can be configured to reduce the transmission power of the 5G signal to a power setting or level that is sufficient to provide service to the airport terminal but has little to no risk of interfering with the aircraft's altimeter, thereby allowing the 5G tower to operate at full power when airplanes are not landing or near the airport, and at a reduced power that is still sufficient to service the terminal when airplanes are landing or near the airport.

To achieve these results, a SON algorithm may be implemented. In some configurations, a suitable SON module updates and maintains one or more of the following 6 parameters, which can be retained in the gNB/BBU: (1) Latest Update Time; (2) Mitigation Technique; (3) Power Attenuation Amount; (4) Down Tilt Amount; (5) SON Expiration Timer; and (6) Restoration Timer. These parameters are explained in more detail below.

Latest Updated Time: The SON algorithm can be configured to store a parameter relating to the last time a parameter was updated or validated in the system, such as a parameter being updated at the BBU. This parameter may be updated by the SON algorithm every time another parameter is validated or updated in the BBU. In some configurations, this parameter can be updated when SON validates the various parameters even if the other parameters remain unchanged.

Mitigation Technique: The SON algorithm can be configured to store a parameter relating to one or more recommended mitigation technique selected from a list of potential mitigation techniques. The potential mitigation techniques may include: take no action; change the tilt of the transmission; reduce or otherwise attenuate the power of a transmitted signal; cease signal transmission; lock the remote radio head; or any combination of the foregoing. It has been found that these mitigation techniques can be sufficient to reduce or otherwise eliminate interference between a 5G transmission site and an aircraft LRRA. Nevertheless, in some configurations, other mitigation techniques known to those of skill in the art may be employed as well.

Power Attenuation Amount: The SON algorithm can be configured to store a parameter relating to an appropriate power attenuation amount. This parameter may alter the output of the 5G transmission site. For instance, the 5G transmission site may be attenuated in a range from about 0 to 46 dB in various embodiments. In some configurations, the SON algorithm can be configured such that if this attenuation brings the RRH power below the minimum supported value of RRH, the BBU will lock RRH instead.

Downtilt Amount: The SON algorithm can be configured to store a parameter relating to an appropriate downtilt amount. In various configurations, this downtilt can range from about 0 to 20 degrees. Likewise, the system can be configured such that if this downtilt is outside of the supported range of Antenna, BBU locks RRH instead.

SON Expiration Timer: The SON algorithm can be configured to store a parameter relating to an appropriate expiration timer. In some embodiments, the expiration timer may range from about 0 to 1440 minutes. Depending on the selected configuration, the system can be configured such that if the time difference between the current time and the latest updated time exceeds the expiration timer, then the gNB can be configured to implement a predetermined interference reduction technique, such as locking the RRH as soon as a potential LRRA signal is detected in order to ensure the safety of nearby aircraft.

Restoral Timer: The SON algorithm can be configured to store a parameter relating to an appropriate restoral timer. The restoral timer can relate to the time it takes for the system to restore the original configuration prior to detecting the potential LRRA signal. In some embodiments, the restoral timer may range from about 0 to 1440 minutes.

In addition to the foregoing, the following statistics may be gathered and maintained for long period of time, such as one year or more if needed. These reports may be used for fine-tuning the SON algorithm, perform risk analysis and identifying high risk sites to apply forced attenuation that may be left unadjusted by the Machine Learning Algorithm. Some of the gathered statistics may include: Machine Learning Changes (such as the maximum transmission power, the maximum tilt, and the like); a timer configured to log the minimum, maximum, and average value of the received suspected altimeter signal over a period of time, such as about 15 Minutes; and a log of the minimum, maximum and average C-band transmission power at the 5G transmission site.

### Mitigation Techniques

As described, the system disclosed herein can be configured to employ one or more interference reduction countermeasures or mitigation techniques based on the detection of a suspected LRRA signal. The interference reduction technique that is employed may be predetermined, dynamically selected by the SON, or otherwise selected through another determination process. Some of the suitable interference reduction countermeasures or interference mitigation techniques that may be employed may include adjusting transmission tilt, reducing transmission power, or halting transmission entirely. These mitigation techniques are discussed in more detail below.

Adjusting Transmission Tilt: The system can be configured to adjust the tilt at which the signal is transmitted. For example, the 5G tower can implement a beamforming protocol by which the electrical tilt of the emitting antenna transmits the signal at a reduced angle to reduce the amount of transmission being emitted into the sky towards potential aircraft. The algorithm may increase the downtilt of the transmission by steps of about 1 degree, or by steps anticipated to reduce the transmission by about 2 dB at a selected position (e.g., azimuth and/or elevation). The system may be configured to determine whether the stepped adjustment is adequate to mitigate the interference, such as to bring the potential for interference down to an acceptable level and may be configured to iteratively adjust the tilt until the interference is reduced, or the potential for interference is brought down to an acceptable level. It will be understood by those skilled in the art that in this or other embodiments, beamforming could similarly be used to steer the beam toward a selected first azimuth range and away from a second azimuth range of interested to reduce or eliminate interference with a receiver located at a position (e.g., azimuth and/or elevation) within the second azimuth range.

Reduce the transmission power in the C-band: The system can be configured to reduce the power at which the system is emitting its signals, such as, by reducing the power at which a 5G tower propagates signals, or particularly signals within a certain frequency range, such as selectively attenuating the power at which the signal is transmitted within the C-band. The system may be configured to determine whether the stepped attenuation amount is adequate to mitigate the interference, such as to bring the potential for interference down to an acceptable level, and may be configured to iteratively adjust the attenuation until the interference is reduced, or the potential for interference is brought down to an acceptable level. Such a level may be ascertained through a variety of methods. By way of example, a suitable level may be predetermined, calculated by an algorithm, or measured.

Halt Transmission: The system can be configured to completely halt transmissions suspected of creating a potential for interference. In some configurations, the system may be configured to halt transmissions in the C-band or a selected portion of the C-band. In other configurations, the system may entirely halt transmissions. Likewise, in various configurations the system can be configured to continue to monitor for the presence of LRRA signals, and when the potential for interference has passed, the system can resume transmitting as normal.

### Pathloss Calculation

In some configurations, it is possible to estimate the distance of the airplane from the receiver (e.g., using the 5G antenna/system itself or using an additional antenna/system) configured to receive the low range altimeter signals. This distance can be used to inform certain interference reduction decisions, as otherwise described.

For example, in some embodiments it is possible for the systems and methods disclosed herein to calculate or otherwise estimate the minimum pathloss of the LRRA signal, based on the magnitude of the LRRA signal received and some known/estimated parameters, such as the lowest likely transmit power of the aircraft LRRA. This calculated or estimated Pathloss can then be used to calculate the level of signal that the LRAA is likely receiving from the 5G eNB transmitter using the formula presented below.

RX₂=TX_{c}−PL₂→RX₂=TX_{c}−(PL₁+0.8)→RX₂=TX_{c}−(TXₐ−RX₁+0.8) Equation 1

In the formula above, the symbols refer to the following elements.
RX₁: A measured variable referring to the level of LRRA signal (e.g., 4.2-4.4 GHz or other frequency associated with selected LRRAs) received by 5 g eNB.
TXa: An estimated variable referring to the lowest likely altimeter transmission power in dBm, which in some configurations may be about 30 dBm.
PL₁: A calculated variable referring to the calculated pathloss from the LRAA to the 5G receiver, in dB. In some recitations of the formula, PL1 may be equal to TXa−RX1.
RX₂: Is a variable referring to the level of the estimated 5G C-band signal received by the LRRA in dBm. This can be the signal from the 5G C-band suspected of causing interference.
TXc: 5G C-band total transmit power in dBm (e.g., about 320 dBm).
PL₂: Is a variable representing the predicted or estimated pathloss from the 5G transmitter to the LRRA. This variable may also be written as PL2=TXc−RX2 (in dB)→RX₂=TX_{c}−PL₂.

Further, PL₂ may be equal to PL₁+0.8 dB, since PL₁ and PL₂ should be generally the same based on the reciprocity principle. However, the formula presented above adds 0.8 dB to approximately account for the difference in frequency between the nominal transmit frequency of the 5G transmitter and the nominal transmit frequency of the LRRA and the impact frequency generally has on pathloss (based on the free-space path loss (FSPL) equation: FSPL (dB)=20 log (d)+20 log (f)+32.44 (where d is distance in kilometers and f is frequency in MHz).

In some configurations, the same or different pathloss calculation can be utilized by an algorithm, such as the SON algorithm, to inform the interference mitigation procedures. For example, in some configurations the SON algorithm or another suitable learning mechanism can be configured to ensure this RX₂ power (i.e., the estimated level of 5G C-band signal received at the LRRA) is not exceeding the levels defined by FAA or other regulatory authority and stays below it by a certain operating margin. If this RX₂ exceeds the limit, the disclosed algorithm can be configured to employ one or more interference reduction countermeasures to reduce the RX₂ levels to a sufficient degree.

The algorithm can further be configured to learn over time, as discussed above. For example, in some embodiments the algorithm can employ a learning mechanism and log the changes made to each 5G transmitter that brought the RX₂ levels down within the normal acceptable range and can apply this same change the next time a LRAA signal is initially detected. The system may then continue to measure and determine if further mitigation is needed (e.g., as aircraft/LRRA position changes over time thereby changing the LRRA signal received at the 5G site).

Likewise, in certain advantageous configurations, a suitable algorithm may use the historical RX₁ measurements in order to identify certain 5G C-band cells or transmission sites as high risk and can set a permanent attenuation to those high risk cells or sites.

Nevertheless, in some configurations, additional or alternate techniques and methods for calculating pathloss may be employed. For instance, in some embodiments a third party or LRRA manufacturer's LRRA Lateral Distance Calculator might be used. Because, the LRRA there may be selected geometric limitations on how far any particular LRRA can transmit and receive signals, this information might also be utilized by the system.

Likewise, in the same or different embodiments, the Free Space Pathloss equation shown below as Equation 2 may be utilized in various ways to estimate or calculate aircraft/LRRA position (e.g. straight line distance between the aircraft/LRRA and 5G site). This equation might also be used to provide a max distance that the LRRA can receive signals from the 5G site based on gain and power of both LRRA and 5G systems. In some embodiments, this information might be used to determine or estimate of how large a buffer zone is needed around each airport. Other assumptions regarding aircraft and LRRA operations can be used to estimate the potential for 5G interference with a LRRA and the need for any associated mitigation techniques or airport buffer zones. For example, it might be reasonable to assume the LRRA has a 60-degree conical transmission cone extending outwardly from the bottom of the aircraft and a maximum aircraft bank angle of 45-degrees.

FSPL=log₁₀(d)+20 log₁₀(f)+32.44−G_{Tx}−G_{Rx} Equation 2

Equation 2 is the Free Space Pathloss equation with antenna gains added to the equation. In Equation 2, d is distance in kilometers, f is frequency in MHz, G_{TX} is overall transmitter antenna gain including feeder losses, and G_{RX} is overall receiver antenna gain including feeder losses,

In still further configurations, the aircraft lateral/diagonal distance may be calculated according to Equations 3 and 4 below, where h stands for the height of the aircraft in feet, b stands for the angle of bank, pitch, or combination thereof in degrees, and a stands for the aperture for the LRRA cone in degrees.

$$Lateral Distance ( ft ) = min ( h * tan ( ( b + \frac{a}{2} ) * \frac{π}{180} ) , 10560 ) \qquad Equation 3$$

$$Diagonal Distance ( ft ) = min ( h \div cos ( ( b + \frac{a}{2} ) * \frac{π}{180} ) , 10560 ) \qquad Equation 4$$

These equations can be used to estimate the distance between the airplane from a given 5G site with consideration to roll and the conical transmission beam of the LRRA. In some embodiments this may be used as a foundation for a geometry-based calculator that gives a line of sight between the 5G antennae and the LRRA considering a maximum possible roll of about 45 degrees and the conical transmission beam of the LRRA which is typically about 60 degrees. The calculator may use the estimated distance between the 5G site and the LRRA antenna (in kilometers, meters, or feet), the gain of the 5G antenna in dBi, the gain of the LRRA antenna in dBi, and the transmission power of one or more of the LRRA and the 5G transmission site in dBm. The aircraft height may be estimated, measured, or otherwise obtained through flight data, ATC or GPS systems, or the like. Through the use of these equations and algorithms, in some embodiments, it is possible to determine a pathloss value corresponding to a distance from a 5G C-band transmission site, which can help estimate a buffer zone around airports. For example, in selected embodiments, these equations can be used to determine an airport buffer zone of concern in which LRRA detection and 5G C-band mitigation techniques might be needed to avoid interference with LRRA operations.

In other embodiments, position information from a supplemental data can be used to determine aircraft position and/or aircraft type and identification, such as ATC data, data from a filed flight plan, aircraft transponder information, or other sources. The system can use this aircraft position and/or aircraft type and identification information can be used to determine the need and type of interference mitigation technique to be used. For example, certain aircraft types may use LRRAs that are not susceptible to 5G interference requiring no interference mitigation at the 5G site. These aircraft might be identified by a code entered on the aircraft flight plan and associated with the aircraft tracking via ATC, and this information could be provided as supplemental data. In other examples, aircraft position from ADS-B or ATC might be provided as supplemental information and this position could be used to determine an appropriate 5G transmission tilt or power setting to mitigate signal interference.

### Use of Supplemental Information

ADS-B systems represent a major step forward in communication between aircraft and other airspace consumers. ADS-B allows equipped aircraft and ground vehicles to broadcast their identification, position, altitude and velocity to other aircraft and ATC. This is called ADS-B Out. The receipt of this information is referred to as ADS-B In. Current transponders enable ATC and other aircraft to know an aircraft's relative position and altitude. ADS-B adds important information to help project and prevent traffic conflicts.

ADS-B is presently required on all commercial and private airplanes. The FAA had a mandatory requirement for all such planes to incorporate ADS-B by 2020, although some have delayed this implementation. Airports equipped with towers have knowledge when airplanes with ADS-B are approaching the airport. Furthermore, the FAA also knows which specific airplanes have altimeters that operate significantly out of the standard LRRA band or are susceptible to 5G interference. This list of airplanes with ADS-B and airplanes with susceptible LRRA can be included in the ATC system. Accordingly, in some embodiments, when an aircraft having a LRRA susceptible to 5G interference approaches an airport, ATC can provide this information (e.g., manually or via automation) to the system so the system can determine that mitigation techniques might be needed. Alternately, when an aircraft operator files a flight plan for an aircraft having a LRRA susceptible to 5G interference, the operator could notify ATC of this information by enter a code in the flight plan. Similarly, this information to allow ATC to track the aircraft and provide the supplemental information to the system so the system can determine that mitigation techniques might be needed.

For example, in selected embodiments, the potential for LRRA interference may be eliminated because aircraft having a susceptible LRRA can be identified near or beyond the edge of an airport facility's airspace (e.g., 20 to 50 miles away from the airport and altitudes of 17,000 feet or greater). At these distances aircraft can be more than 20 minutes away from the airport, providing ample time for ATC to provide this information to the system so the system can determine that mitigation techniques might be needed and so the system can apply mitigation techniques before aircraft operations are impacted (e.g., long before an auto landing procedures is initiated).

The system can be configured to check for other variables as well, such as weather updates to determine if it is a low visibility day or if the runway is wet or contaminated. For example, once the system detects the presence of an LRRA signal, the system may check for updates (such as from an Operational support System (OSS)) before employing a mitigation reduction technique because a mitigation technique might not be required or a different mitigation techniques might be used for differing airport visibility or runway conditions. If there has not been a weather/airport update for a given period, then the BBU may employ the most conservative mitigation technique to prevent LRRA interference. In the event that there is a weather/airport update, the system may determine the appropriate action to take based on the reported conditions.

### Mobile Phone Disabling Based on Pressure, Speed, or Height

To further reduce the potential for interference from cell phones inside aircraft, cell phones can be configured to automatically disable 5G transmission based on pressure, speed, or height. For example, some cell phones have a barometric sensor that can measure and record heights. Although the barometric sensor's accuracy is about 50 feet, the program can estimate height accurately by recording the pressure at two distinct altitudes. In this manner, accuracy can be improved by utilizing the same phone at distinct locations to make the measurements.

Likewise, the speed of the phone may be recorded to determine whether the phone is moving at a suspected aircraft speed, such as greater than 100 miles per hour. For example, when a cell phone is at or above a trigger altitude (e.g., 50 feet) or at or above a trigger speed (e.g., 100 or 120 miles per hour) the phone can be configured to disable it's 5G capabilities. This can help further ensure that it's 5G function is turned off during flight (e.g., at least portions of takeoffs and landings).

### Factors Affecting Selection of Components

As discussed earlier, systems disclosed here in to implement the methods discussed may include use or modification of the existing 5G systems or may include an additional system that can be used separately or integrated with existing 5G systems. These additional systems are referred to herein as snooper boxes. Although component selection and other portions of this disclosure are discussed in terms of snooper boxes, one skilled in the art will understand that many of the techniques and components are equally applicable to the disclosed methods and systems when the 5G system (e.g., antenna/site) is used to sense/detect LRRA signals.

In some embodiments, the snooper box components include one or more of amplifiers, power detectors, and band pass filters. The selection and purpose of the components is discussed in more detail below. For instance, in various embodiments, the system includes an amplifier. The amplifier may be used to amplify the signal and noise received within a certain frequency band.

Likewise, in various embodiments, the system includes a power detector. The power detector may be used to detect LRRA signals. The selected power detector must be fast to react to LRRA signals, since some LRRA signals are emitted in fast, short pulses that may appear for about half a second at one frequency before emitting another spike for about half a second at a frequency close to or at the original frequency, but typically still within the LRRA detection band filter of 4035 to 4135 MHz. As such, in some scenarios a power detector having a short impulse response time is selected.

This frequency range (4035 to 4135 MHz) was selected by using a spectrum analyzer while aircraft with LRRAs susceptible to 5G interference were in range of the spectrum analyzer. This method was deployed for at least seven airplanes identified by the FAA as having LRRA having 5G interference issues. These data were analyzed and it was observed several spikes occur near the boundary or outside of the LRRA assigned frequency band 4.2 to 4.4 GHZ as well as near or outside the 5G C-band assigned frequency band of 3.7 to 3.98 GHz. This led to the selection of a band pass filter for the range 4.035 GHz to 4.135 GHz.

Similarly, the systems disclosed herein can be configured to operate under very low power levels. For instance, the systems disclosed herein can be configured to detect and respond to signals transmitted over about-80 dBm of noise floor with aircraft signals being detected from about-2 dBm to-20 dBm. The detected signals can represent an increase of about 2 to 20 dBm over the noise floor. As such, the system may include a logarithmic power detector capable of operating in nano seconds. A suitable detector provides a better chance of generating a voltage difference between the received noise alone and the received noise plus signal.

Accordingly, in various embodiments the system may include a band pass filter ranging from 4035-4135 MHz. In some configurations, the band pass filter may require a minimum power of about-64 dBm, so it can be necessary to amplify the received signal prior to passing the signal through the band pass filter before the signal is sent to the logarithmic power detector. This can also result in a higher signal to noise ratio.

In various embodiments, the components selected exhibit excellent temperature stability within the temperature ranges of about −30 to +85 Celsius. It has been found that generally speaking, little variation in functionality was detected at different temperatures. For instance, at −30 degrees Celsius the noise was found to be −108 dBm. At about 85 degrees Celsius the noise was found to be about −106.2 dBm. As such, it was concluded that at GHz frequencies, ambient temperature did not affect the thermal noise in any significant way.

In various embodiments, the system can be built to IP67 compliance which provides excellent protection against harsh ambient environment and moisture,

### Band Pass Filter

A challenge of present approaches is to obtain a signal through a system exhibiting an acceptable insertion-loss and voltage standing wave ratio (VSWR). Another challenge was to design a band pass filter with an acceptable power requirement—since a minimum power to activate the band pass filter may be as low as about −69 dBm. Configuring a system that will exhibit these qualities yet further maintain a tight rejection both in upper and lower bands of the band pass can be difficult to achieve.

In some embodiments, the present system implements an amplifier used before the band pass filter to rectify some of these deficiencies. In this manner, the present system can be used to amplify a much wider range of frequencies than just the needed detection band of 3730 to 4555 GHz. This is done so that even the smallest spikes of interference will be amplified before passing through the band pass filter,

After the signal is passed through the band pass filter, the second amplifier is used. The second amplifier can be used to only amplify signals passed through the band pass filter. The signal levels become more pronounced this way because frequency range is smaller. To improve the signal to noise ratio, a 20 dB amplifier in the frequency range of about 3700-4600 MHz may be used.

Table 2, below, includes some parameters of various band pass filters that may be used in conjunction with the systems, techniques, and methods disclosed herein. Note that band pass filters may be required to cancel background noise, including noise produced by satellite emissions (e.g., noise floor cancelation).

TABLE 2
Band Pass Filter Designs

| Band Pass Filter | Purpose |
|---|---|
| CTR Frequency: 4500 MHz, | Noise floor cancelation if needed |
| Pass Band: 4445-4555 MHz | |
| CTR Frequency: 4300 MHz, | Frequency band for LRRA not |
| Pass Band 4250-4350 MHz | susceptible to 5G interference |
| CTR Frequency: 4085 MHz, | First Group of airplanes with LRRA |
| Pass Band: 4035-4135 MHz | susceptible to 5G interference |

Other requirements common between band pass filters: Insertion loss less than 2 dB, VSWR less than 1.5 dB, Upper/Lower band Rejections at 30 dB, SMA connectors, IP 67

### Antennae

Disclosed below are two types of Omni antennas that are suitable for use in the snooper box system. A suitable antenna should be designed to have a wide horizontal polarization and an upward max vertical polarization at 6-10 degrees to reduce the likelihood that such an antenna would detect 5G C-band signals.

Additionally, these Omni antennas are designed to operate between about 3700 GHz to about 4600 GHz. This frequency band is chosen to include all ranges of frequencies including the band of interest ranging from 3790-4400 MHz.

### Detection of Problems Within the System

Any system is subject to failure. The present system has been designed to greatly reduce the chance of failure, and to further reduce the likelihood of a catastrophic event even in the case of a failure. In the event of a failure, an alarm may be generated to alert the operator to maintain, repair, or replace the system.

In a first embodiment, when a failure alarm condition is present, the BBU may be notified of the alarm. If the system is configured to have access to ADS-B information through the OSS or ATC system, then the system may still be configured to employ mitigation techniques based on the presence of an aircraft as determined by the ATC or ADS-B supplemental information. In this way, interference reduction countermeasures may still be employed despite the failure of certain components, such as a band pass filter or amplifier.

In the same or different embodiment, the system can be configured to have a complete redundant circuit. In this manner, if a first circuit fails and an alarm condition is raised, the system can be configured to rely on the operation of a redundant circuit until an operator can repair the system.

### Certain Embodiments

Certain embodiments of the presently disclosed systems and methods are disclosed below to illustrate certain embodiments and provide functional examples. It will be understood that this disclosure is not limited to any of the specific implementations discussed below, and that various additional and alternate implementations are contemplated by the present disclosure.

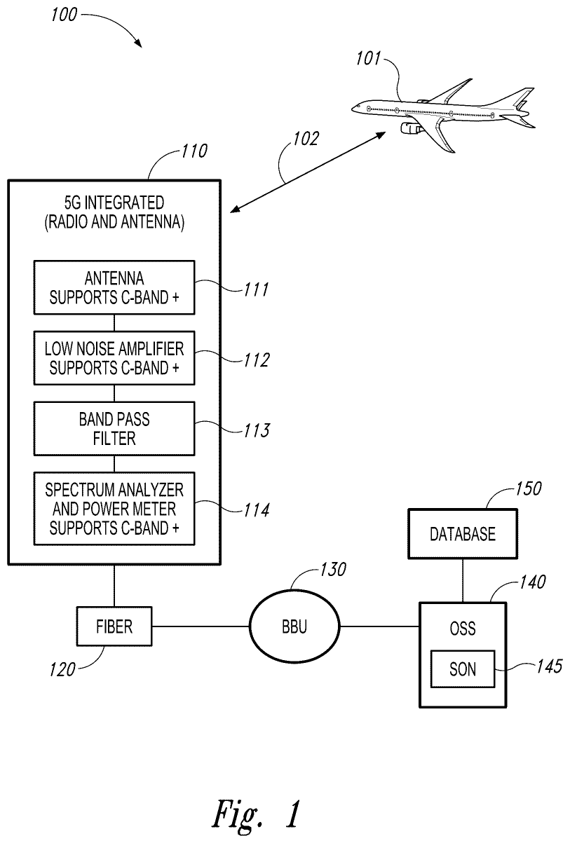

In a first embodiment an enhanced, integrated 5G antenna is utilized. The enhanced, integrated 5G antenna can be configured to receive and process LRRA signals ranging from about 4035 MHz to about 4135 MHz. A schematic of a suitable system prepared in accordance with this embodiment is depicted in FIG. 1.

FIG. 1 depicts such a system 100 including a revised 5G integrated antenna and radio configured to detect LRRA signals, such as LRRA signals in the range of about 4035 MHz to about 4135 MHz and in some embodiments further up to about 4155 MHz. Based on the detection of such signals, the system can be configured to request that the BBU power down or adjust the tilt of the transmission. The determination may be based on pathloss calculations or other measured or determined characteristics.

More specifically, as shown in FIG. 1 the system 100 may include an enhanced, integrated 5G radio antenna 110 configured to detect LRRA signals 102 emitted from an aircraft 101. The enhanced integrated 5G radio antenna 110 may include an antenna 111 configured to support C-band signal emission and reception; a low noise amplifier or LNA 112 configured to amplify received signals; a band pass filter 113 configured to isolate a portion of a signal of interest; and a spectrum analyzer or other suitable power meter or detector 114 configured to identify even low dBm spikes in the received signals. In some embodiments, the band pass filter 113 may have a passband of about 4035-4135 MHz.

In some configurations, the enhanced integrated 5G radio antenna 110 can interface with the base band unit (BBU) 130 through a fiber connection 120. In this manner, the detection of a suspected LRRA signal can be communicated to the base band unit 130 through the fiber connection 120. Likewise, the base band unit 130 can be configured to take corrective action based upon the detection of a suspected LRRA signal, such as reducing the power of the 5G signal transmission, tilting the beam down, or entirely ceasing the signal transmission. In the same or different configurations, the base band unit 130 may be in communication with one or more operational support systems (OSS) 140 that can provide additional functionality, such as interfacing with one or more databases 150 to obtain FAA data, ADS-B data, weather updates, runway condition updates, visibility updates, or the like. Similarly, in some embodiments the one or more operational support systems (OSS) 140 may be configured to interface with a SON algorithm 145, which can determine an appropriate interference mitigation routine based upon detected characteristics of the received signal, data obtained from the one or more databases 150, or similar inputs. Likewise, the SON algorithm 145 can facilitate additional functionality including data retention, machine learning, and any of a variety of different mechanisms to improve the performance of the system over time.

For example, in one embodiment, the SON algorithm 145 may include one or more of data retention and adaptive functionality, such as machine learning. In some configurations, the system can be configured to log each instance of interference and determine the frequency of interference events, along with the calculated severity or detected power level of each event. Based upon the detected characteristics of the particular system placement and logged interference events, the system can be configured to request an update or automatically implement an improved interference mitigation routine, such as increasing or decreasing the mechanical or electrical down tilt of the emitted signals, and/or operate at a reduced power level. Once a critical threshold value for one or more relevant interference mitigation routines is reached, the antenna can be set and maintained at the identified threshold value. Such an approach can be particularly advantageous on a sector-by-sector basis to automatically identify the optimal operational values for each signal emitter in an affected area.

In other configurations, a separate antenna can be implemented to achieve the desired functionality. The second antenna may be configured to interface with pre-integrated circuitry at the 5G emission site or can be configured to interface with one or more intermediate circuits before passing a signal to the 5G emission site.

As such, various implementations of this configuration may include the use of an external antenna and system completely independent of existing 5G C-band antenna, herein referred to as a snooper box. This system can be configured to connect to an existing alarm box at a cell tower location, which can be configured to respond to signals detected by the external system and request snooper box replacement or repairs. The disclosed embodiment can also be configured to connect directly to the emission site's BBU which in turn communication with the Operational Support Systems (OSS) to allow for the verification of weather, visibility, runway condition, ATC, ADS-B, or other data. This data or supplemental data can be used to determine or override interference mitigation decisions. For instance, on high visibility days the system can be configured to take reduced action, such as lowering the transmission strength by a reduced amount.

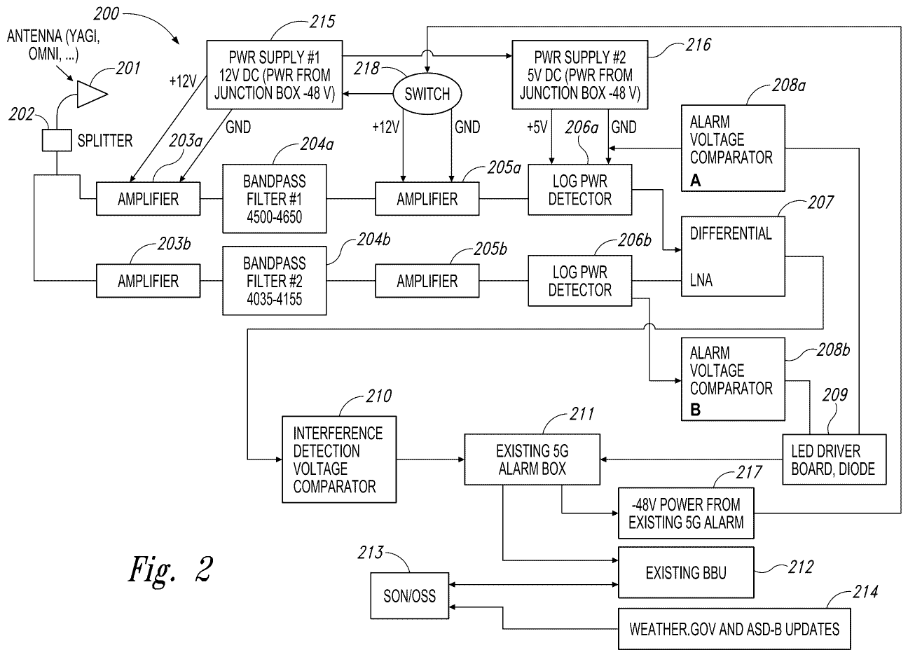

A second embodiment of a suitable system including a separate antenna is depicted in FIG. 2. As described, the system 200 depicted in FIG. 2 includes a separate antenna 201. The antenna may be any suitable antenna such as an omni-directional antenna or another directional antenna. The antenna may be used to detect signals suspected of being LRRA emissions. In the event that a suspected LRRA emission is detected, the signal may be sent to a splitter 202 configured to split the signal into a pair of low noise amplifiers 203a and 203b. The amplifiers 203a and 203b may be used to amplify the detected signal before passing it through one or more band pass filters.

It has been found that the use of multiple band pass filters can provide significant and advantageous functionality to the disclosed system. For instance, it has been found that in some cases there is a persistent noise floor at broad band frequencies of about-80 dBm, and in some cases can range from about 4.5 GHz to about 4.65 GHz. When a suspected LRRA signal is detected, the signature of the suspected LRRA signal appears in addition to the persistent noise floor.

To cancel this noise two band pass filters can be used as two separate circuits. As shown in FIG. 2, the amplified signal is passed through two band pass filters 204a and 204b in parallel; the first band pass filter 204a is configured with a band pass ranging from about 4500 MHz to about 4650 MHz, while the second band pass filter 204b is configured with a band pass ranging from about 4035 MHz to about 4155 MHz.

The first band pass filter 204a, having a band pass ranging from about 4500 MHz to about 4650 MHz, may be used to create a voltage due to the detected power from the persistent noise floor. A second band pass filter 204b, having a band pass ranging from about 4035 to about 4155 MHz, can be configured to detect the suspected LRRA signal. This second band pass filter 204b generates a larger voltage due to the addition of the signal originating from the persistent noise floor and the suspected LRRA signal. This added power can generate a different frequency at the 4.5 GHz to 4.65 GHz band pass circuit. Although the foregoing discussion has made specific use of precise bands passed by the band pass filters, it will be appreciated that additional or alternate band pass filter configurations may be employed configured to pass additional or alternate frequencies.

The signal from each band pass filter 204a and 204b can be passed through one or more amplifiers, such as a first and second amplifier 205a and 205b as shown in FIG. 2. The one or more amplifiers 205a and 205b can then pass the amplified signal to one or more logarithmic power detectors 206a and 206b. In this manner, the logarithmic power detectors 206a and 206b can feed the signal forward to one or more of a differential low noise amplifier 207 to further amplify the signal and an alarm voltage comparator 208a, 208b.

However, it will be appreciated that other configurations may be employed as well. For instance, in some embodiments only one series of amplifiers, band pass filter, and logarithmic power detected may be employed such that amplifier 203a, band pass filter 204a, amplifier 205a, and logarithmic power detector 206a may be optional, with any remaining connections affixed to like components.

The one or more alarm voltage comparator 208a, 208b may be configured to identify the presence of a suspected LRRA emission and communicate a signal to a LED Driver Board 209 or other diode to alert a user to the detection of a suspected LRRA emission. The system 200 can be configured to obtain power from existing power connections at the 5G transmission site, or other power connections. In the embodiment depicted, the system is powered by a first power supply 215 comprising a 12 v DC connection which can be a connection to a junction box at the 5G transmission site. A second power supply 216 may comprise a 5 v DC connection to a junction box at the 5G transmission site.

In some configurations, the differential low noise amplifier 207 may amplify the signal before it is processed and an interference detection voltage comparator 210. The interference detection voltage comparator 210 can be configured to recognize the voltage differences generated by different band pass filters in order to create a predesignated voltage for each circuit and thereby detect the presence of a suspected LRRA signal. In the event that a suspected LRRA signal is detected, the interference detection voltage comparator 210 may send a signal to the 5G alarm box 211, which may include a −48V power connection 217. The 5G alarm box 211 may alert a user to the detection status and can send a signal to the BBU 212 to implement one or more interference reduction techniques. Similarly, the BBU 212 may be in communication with one or more Operational Support Systems (OSS) 213 which may include one or more SON algorithms or other database connections. For instance, in some embodiments the BBU 212 may be in communication with one or more databases 214 containing ADS-B data, ATC information, weather data, visibility data, runway condition data, or other relevant information pertaining to interference reduction decisions,

Some configurations of the presently disclosed system may be configured to utilize a single band pass filter. Some of these embodiments can be particularly useful to detect suspected LRRA emissions from aircraft that transmit and receive outside of their designated band of about 4.2 GHz to about 4.4 GHz. Generally speaking, experimental testing has shown that these aircraft tend to transmit broadly from about 3.5 GHz to about 4.4 GHz and may be associated with LRRA that are particularly susceptible to 5G interference.

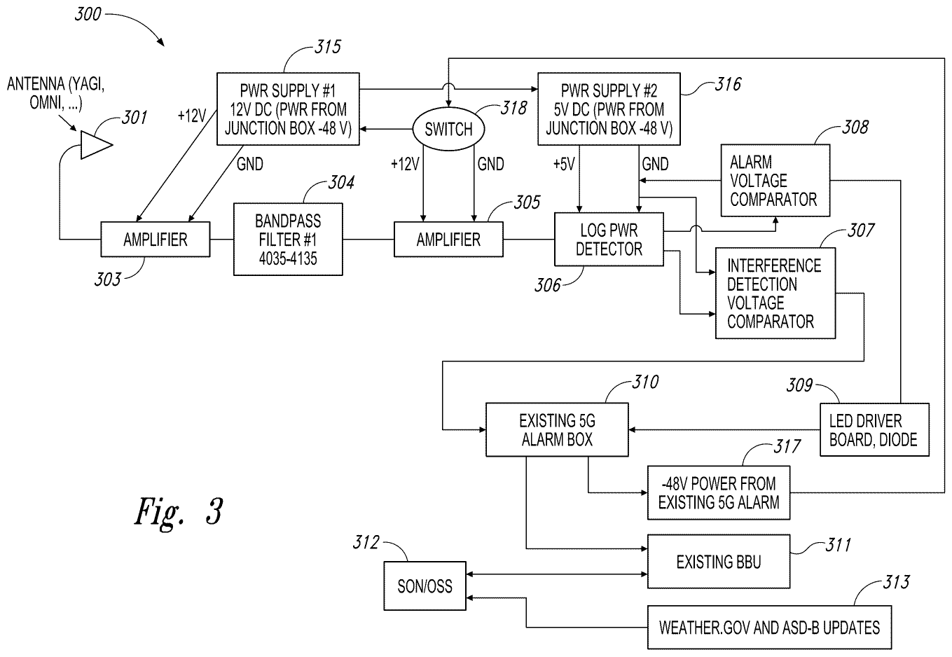

A suitable schematic for such a system is depicted in FIG. 3. As depicted in FIG. 3, a suitable system 300 may include an antenna 301. The antenna may be any antenna suitable for receiving signals such as an omnidirectional antenna or Yagi directional antenna. In some embodiments the antenna 301 may be configured to interface with a splitter to split the received emission into one or more signals. The signal(s) relating to the received emission may be transmitted to a first amplifier 303. The first amplifier 303 may be any suitable amplifier, such as a low noise RF amplifier.

As further depicted in FIG. 3, the first amplifier 303 can be configured to amplify the received signal before transmitting the signal through a band pass filter 304. In the presently depicted embodiment, the band pass filter is configured with a band pass of about 4.035 GHz to about 4.135 GHz. In this manner, only the desired portion of the amplified signal may proceed to the second amplifier 305. The second amplifier may be employed to further amplify the portion of the signal emitted through the band pass filter 304. The amplifier 305 feeds the amplified signal to a logarithmic power detector 306. In some configurations, logarithmic power detector 306 may be coupled with the alarm voltage comparator 308. Although the foregoing discussion has made specific use of precise bands passed by the band pass filters, it will be appreciated that additional or alternate band pass filter configurations may be employed and/or configured to pass additional or alternate frequencies.

As such, if no suspected LRRA signals are received, then the voltage generated by the logarithmic power detector 306 will remain at a certain baseline voltage level. However, if a suspected LRRA signal is emitted into the system, then the voltage will be increased due to additive affects between the power floor and the detected signal. The increased voltage can be detected by an interference detection voltage comparator 307 which can be configured to detect when an increase in voltage has occurred. In the event that an increase in voltage is detected, the voltage comparator can generate a signal to a 5G alarm box 310. The alarm box 310 can be configured to interface with the BBU 311 of the 5G emission site and thereby employ one or more interference reduction countermeasures. The alarm box 310 may interface with a −48V power connection 317. The −48V power connection 317 can also interface with a switch 318 that interfaces with the first amplifier 303 and a first power supply 315. The first power supply 315 also interfaces with the first amplifier 303. A second power supply 316 interfaces with the logarithmic power detector 306.

The interference reduction countermeasures may be pre-programmed into the BBU 311 or may be predetermined or dynamically computed, such as through connecting to one or more Operational Support Systems 312 or one or more algorithms such as a SON algorithm as described herein. In some configurations, the Operational Support Systems can be in communication with one or more databases 313, such as a database containing ADS-B, ATC, or weather information. In these configurations, the interference reduction countermeasure decision may be at least partially informed by such data, including for example, aircraft identification information, weather information, visibility information, and the like.

The systems disclosed herein can be equipped with alarm interfaces to alert users or operators of potential detections of suspected LRRA emissions and of potential problems occurring within the system. In various configurations, alarms may be used for various network elements to convey an issue with an element of the system to a user or an operational support system. Within the industry, at least two types of alarms are typically utilized including critical alarms which are service effecting and non-critical alarms which are non-service affecting. In various embodiments, the systems disclosed herein may be considered critical and service affecting. Likewise, in various configurations the systems disclosed herein may be configured to interface with an existing 5G alarm box using shielded cat 5E cables and shielded RJ45 connectors, though other similar connection methods known to those of skill in the art are suitable as well.

In various embodiments of the disclosed system, the system may include at least three LED lights. These lights may have differing colors and may be illuminated under differing circumstances to alert a user to different potential statuses. For instance, in some configurations, the systems may be configured with: a white LED which can be used to indicate that the box is operational and no suspected LRRA emission is currently being detected; an orange LED which can be used to indicate that the system is operational and is detecting a suspected LRRA emission or a transmission from a LRRA that is susceptible to 5G interference; and a Red LED which can be used to indicate that a component within the system is defective and therefore it may not detect any interference. In the event that a system component is suspected of malfunctioning, the system can be configured to revert to a predefined configuration-such as employing the strictest interference mitigation techniques to ensure there will be no interference while the system is being repaired. In other configurations, the system may transmit a signal to the Operational Support System which may receive the alarm and based on an algorithm of machine learning it will set the Power and tilt to a predefined level.

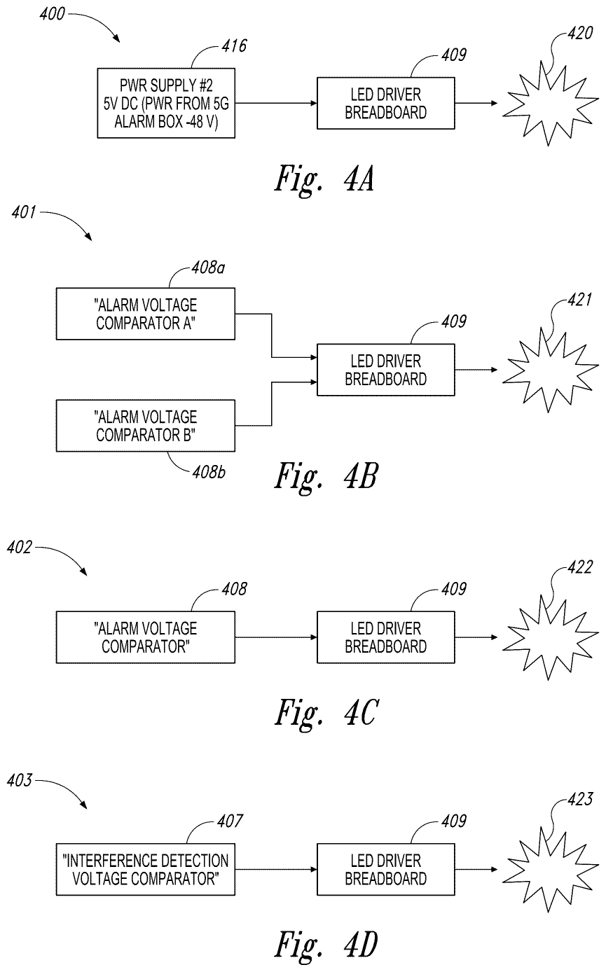

Some schematics of representative LED alarm configurations are disclosed in FIGS. 4A-D and discussed below.

FIG. 4A depicts a suitable schematic for a white LED status light as discussed above. As shown in FIG. 4A, the system 400 may include a power supply connection 416 configured to supply power to the LED Driver Board 409, which can in turn actuate the white LED status light 420. In this manner, when the system 400 has power, the white LED status light 420 may be illuminated,

FIG. 4B depicts a suitable schematic for a system 401 including a red LED alarm light as discussed above. This configuration is particularly advantageous for systems implementing a plurality of alarm voltage comparators. For instance, in the schematic shown in FIG. 4B, the system 401 includes two inputs: one from a first alarm voltage comparator 408a and one from a second alarm voltage comparator 408b. These inputs are fed into the LED Driver Breadboard 409. In turn, in communication with the LED Driver Breadboard 409 is the red LED alarm light 421. In this manner, the red LED alarm light 421 may be illuminated based on inputs from the first and second alarm voltage comparators 408a and 408b.

FIG. 4C depicts a suitable schematic for a red LED alarm light as discussed above. In some embodiments, this configuration can be particularly advantageous for systems implementing a single alarm voltage comparator. In the disclosed embodiment, the system 402 includes an input from an alarm voltage comparator 408. The alarm voltage comparator 408 is configured to interface with a LED Driver Breadboard 409 which is in turn in communication with a red LED alarm light 422. In this manner, the system can be configured to illuminate the red LED alarm light 422 based on inputs from the alarm voltage comparator 408.

FIG. 4D depicts a suitable schematic for an orange LED alarm light as discussed above. The orange LED alarm light may be used to alert an operator of the detection of a suspected LRRA signal. In some configurations, the system 403 may include an input from an interference detection voltage comparator 407. The interference detection voltage comparator 407 is shown in FIG. 4D to be in communication with the LED Driver Breadboard 409, which is in turn connected to the orange LED alarm light 423. In this manner, the system can be configured to illuminate the orange LED alarm light 423 based on inputs from the interference detection voltage comparator 407.

The systems and devices disclosed herein require power to operate. In many configurations, the systems and devices can be equipped with their own power source or can be configured to interface with existing power sources at the 5G emission site. Likewise, in some configurations the systems and devices may be located in direct proximity to the 5G emission site or may be located some distance away from the emission site of interest. In some embodiments where the systems and devices are installed outside of the immediate proximity of the emission site, amplification may be required due to power losses in the cable over these distances.

Regardless, in many configurations the systems and devices disclosed herein can be powered by connecting the disclosed system to the existing alarm box located at the 5G emission site. Through this connection, the presently disclosed systems can be powered and can carry alarm signals from the presently disclosed system to the existing 5G alarm box.

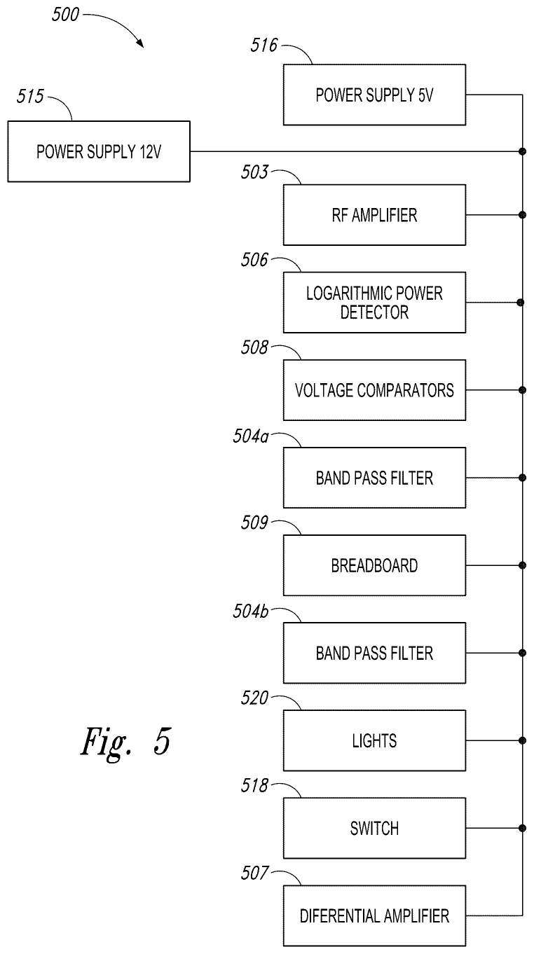

FIG. 5 shows a suitable schematic for powering the components disclosed herein. As shown in FIG. 5, the system 500 includes a first (12-volt) power input 515. The first (12-volt) power input 515 may be an external connection or a connection to the existing junction box of the 5G emission site. For example, in some embodiments the first (12-volt) power input 515 may be derived from the existing 5G emission site alarm box via one or more Cat 5E cables. Likewise, the system 500 includes a second (5-volt) power input 516, which also may be derived externally or through connecting to an existing 5G emission site power conduit. In some configurations a −48V ground connection may come from the existing 5G alarm box via cat 5E cabling. In the depicted embodiment, the first (12-volt) power input 515 and the second (5-volt) power input 516 are in electrical communication with an amplifier 503 configured to amplify received signals; a logarithmic power detector 506 configured to detect received signals; one or more voltage comparators 508 configured to detect a difference in voltage based upon the receipt of a signal; a first band pass filter 504a configured to isolate a portion of interest of a received signal; a breadboard 509 or other circuit configured to provide additional connections; a second band pass filter 504b configured to isolate a portion of interest of a received signal; one or more lights 520 configured to alert a user to an operational status of the device; a switch 518 configured with various functionality, such as to enable or disable the device; and a differential amplifier 507 configured to further amplify a received and/or processed signal.

### EXAMPLES

### Example 1—Antennae Testing

Testing was performed to determine the characteristics of a suitable antenna operating in the range of about 3500-4600 MHz. A first omnidirectional antenna was selected as follows. An FRP radome was selected having an antenna size of about @46 mm×265 mm (excluding connectors) and having a wight of about 485 g, and an antenna number of 1.2.3,

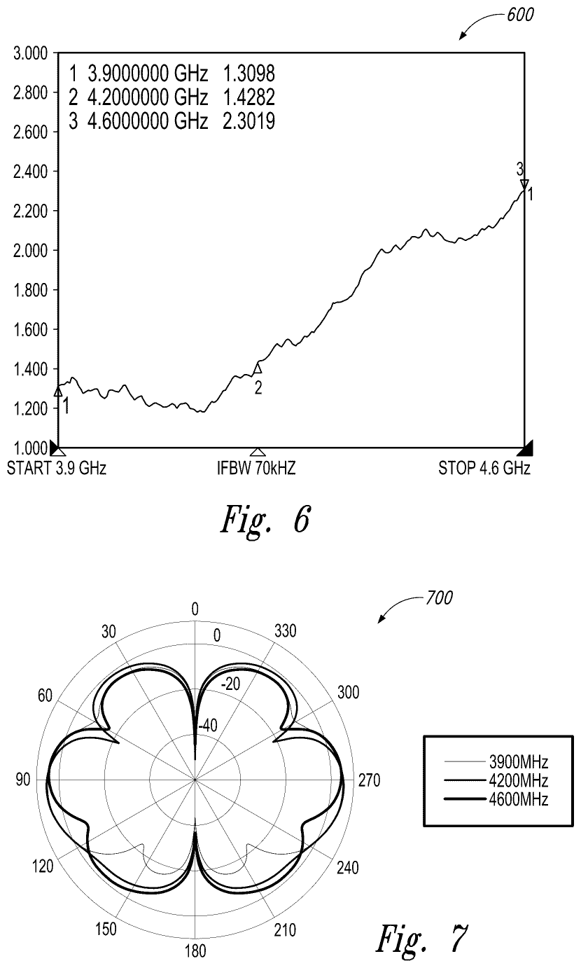

The standing wave and voltage standing wave ratio (VSWR) test results of the first antenna are shown as a screenshot 600 in FIG. 6. According to the test results, in the working band, the port standing wave of the antenna is less than 2.3, indicating a relatively acceptable match between the antenna and the system.

The directionality of the antenna was also tested, and those findings are displayed in the table below and shown in plot 700 in FIG. 7.

TABLE 2

| Frequency (MHz) | Max (dBi) | Beamwidth (deg) |
|---|---|---|
| 3900 | 5.68 | 15.1 |
| 4200 | 5.68 | 14.3 |
| 4600 | 4.77 | 13.1 |

Further testing was performed on a second antenna to determine suitable characteristics of an antenna for use in a system as presently described.

The second antenna was an omnidirectional antenna configured to operate in the band of about 3500-4600 MHz. The second, longer omnidirectional antenna had a radome comprised of ABS. The antenna size was φ46 mm×375.8 mm excluding connectors and the weight was 420 g. The antenna number was 1.2.3.

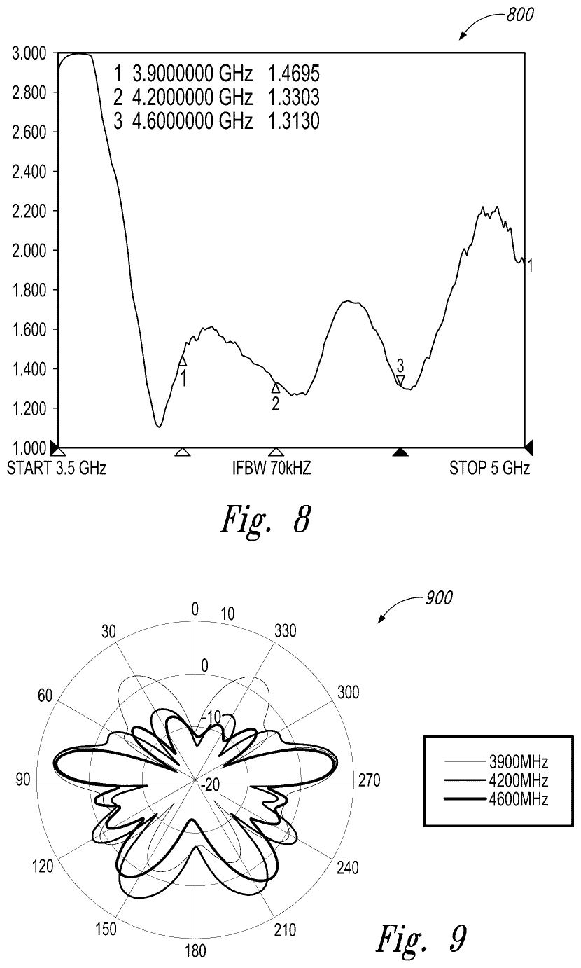

The standing wave test results of the second antenna are shown in a screenshot 800 in FIG. 8. According to the test results, in the working band, the port standing wave of the antenna is less than 2.0, indicating an acceptable match between the antenna and the system.

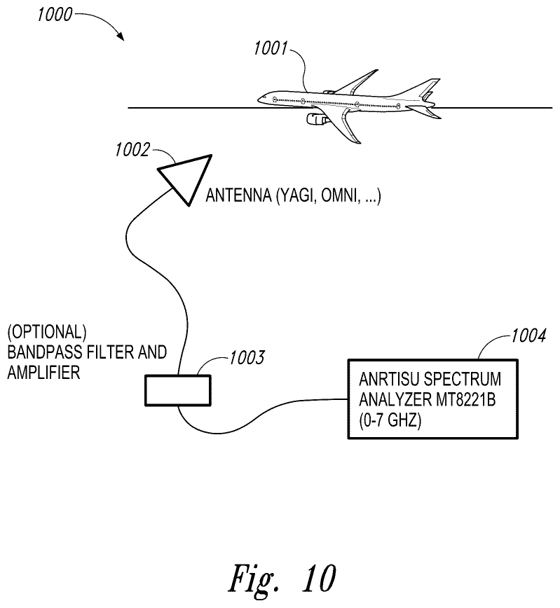

The directionality of the antenna was also tested. The test results are shown in plot 900 in FIG. 9, and in the following table. In the operating band, the gain is greater than 3.79 dBi, the beam width is about 30 degrees, and the non-roundness is less than 3 dB

| No# | Frequency (MHz) | Max (dBi) | Beamwidth (deg) |
|---|---|---|---|
| 2 | 3900 | 4.61 | 34.1 |
| | 4200 | 5.76 | 29.5 |
| | 4600 | 3.79 | 24.9 |

### Example 2—Logarithmic Power Detector Testing

Next, a suitable logarithmic power detector was tested to determine whether the detector would be accurate within 2 dBm and have sufficient sensitization to low dBm changes resulting in noticeable voltage difference that the voltage comparator can recognize.

The table below shows the results of testing a suitable logarithmic detector for accuracy:

TABLE 3

| | Voltage @50 | Voltage @ 500 | Voltage @ 1000 |
|---|---|---|---|
| dBm | MHz | MHz | MHz |
| 0 | 0.77 | 0.932 | 0.91 |
| −5 | 0.77 | 0.932 | 0.91 |
| −10 | 0.832 | 0.932 | 0.91 |
| −15 | 0.955 | 0.932 | 0.91 |
| −20 | 1.078 | 1.063 | 1.045 |
| −25 | 1.199 | 1.185 | 1.165 |
| −30 | 1.322 | 1.308 | 1.288 |
| −35 | 1.422 | 1.426 | 1.407 |
| −40 | 1.561 | 1.548 | 1.53 |
| −45 | 1.678 | 1.668 | 1.684 |
| −50 | 1.791 | 1.787 | 1.777 |
| −55 | 1.9 | 1.899 | 1.891 |
| −60 | 1.999 | 1.998 | 1.995 |

manufacturer claims −2 dBm accuracy at all dBm's
and Range of Frequencies. Verified by testing:

| | |
|---|---|
| calibration | 0.955 |
| offset | −16 |
| gain | −42.2 |

| | Measured dBm | Measured dBm | Measured dBm |
|---|---|---|---|
| dBm | @50 MHz | @500 MHz | @1000 MHz |
| 0 | | | |
| −5 | | | |
| −10 | | | |
| −15 | −16 | −15 | −14.1 |
| −20 | −21.2 | −20.6 | −19.8 |
| −25 | −26.3 | −25.7 | −24.9 |
| −30 | −31.5 | −30.9 | −30.1 |
| −35 | −36.6 | −35.9 | −35.1 |
| −40 | −41.6 | −41 | −40.3 |
| −45 | −46.5 | −46.1 | −45.2 |
| −50 | −51.3 | −51.5 | −50.7 |
| −55 | −55.9 | −55.8 | −55.5 |
| −60 | −60.1 | −60 | −59.9 |

### Example 3—Field Testing

Field testing was performed to test for LRRA detection capabilities to assess the feasibility of detecting LRRA which may be susceptible to interference from 5G signals, despite the guard band frequency range of about 220 MHz purportedly separating the two systems. Field testing was performed utilizing a spectrum analyzer, an external antenna, amplifiers, and band pass filters specifically designed for testing LRRA out of band transmissions.

The field testing was guided by principle of reciprocity. According to antenna reciprocity, the ratio of transmitted power from the transmitting antenna to the received power of the receiving antenna can generally be expected to remain relatively constant.

During field testing using a spectrum analyzer, the premise was that the receipt of signals emitted by a suspected LRRA would indicate that the LRRA is likely to reciprocally receive signals regardless of the original emission type (e.g., either Pulse or FMCW LRRA emissions),

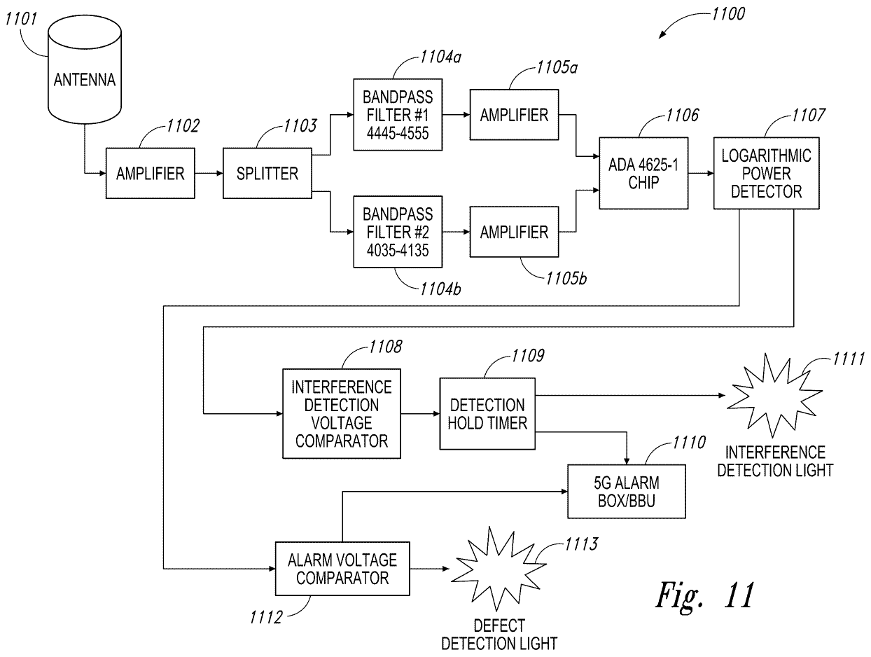

Here, field testing was performed for about 210 airplanes at three airports. Data pertaining to these 210 aircraft provide a significant and reliable source to arrive at the conclusion of the grouping. FIG. 10 depicts an experimental set up consistent with that used to obtain the experimental results disclosed herein. Specifically, FIG. 10 depicts a system 1000 configured to identify the presence of an aircraft 1001 by detecting low range radio altimeter transmissions at an antenna 1002. The detected signals may be transmitted through a band pass filters and/or an amplifiers 1003 to amplify or isolate portions of interest of the detected signal. The detected signal can then be passed through a spectrum analyzer 1004, such as an Anritsu Spectrum Analyzer MT8821B having receptivity in the band of about 0 to about 7 GHZ.

More specifically, the experimental testing was conducted using a handheld Yagi antenna, omni-directional antenna, or other directional antenna configured to receive signals having a frequency of about 0-6000 MHz, the antenna having about 7 dBi of gain. The antenna was pointed to the airplane when the airplane was on approach about 2 miles away from the test site. Aircraft position was confirmed using flight tracker24 and other maps to validate distance and height. The antenna was pointed steadily at the aircraft until the aircraft passed over head and was about 2 miles away in the opposite direction on a line extending from the applicable runway at the airport.

The testing was done for three low visibility airports around the Seattle area including SeaTac, King County and Snohomish County. This testing was done at various stationary points with the airplane at various heights between 1,200 ft to 600 ft.

During testing, it was observed that at some point about a mile or more away from the testing site and about 1100 elevation the spectrum analyzer indicated signal detection at both ends of the approach (extended runway) line for a duration of about 45 seconds. Some of the detections were identified as aircraft with FMCW type LRRA and some with pulse type LRRA, based on the signature of the signal.

Notably, the FMCW type LRRA detections occurred rapidly and repeatedly in a about second and were mostly localized with occasional out of band emissions. On the other hand, the pulse type LRRA signal detections were mostly broad and often out of the designated 4200-4400 MHz band. In some instances, the detected signals ranged all the way down to about 3550 MHz.

Therefore, it was concluded that detected pulse type LRRA appear to be consistently transmitting and operating out of their assigned band of about 4200-4400 MHz and understood to be susceptible with 5G signal interference which may cause LRRA saturation and interfere with proper LRRA functionality. Similarly, the FMCW type LRRA appear to have some out of band emissions, as noted above.

Observed data pertaining to some of the most relevant aircraft have been tabulated in the table below.

TABLE 4

| | Start | Stop | | REF | | | | Sweep | LRRA | | | |
|---|---|---|---|---|---|---|---|---|---|---|---|---|
| | Freq | Freq | Span | Level | Input | RBW | VBW | Time | Detection | Out of | Transmit | Transmit |
| Run # | MHz | MHz | MHz | dBm | att. | MHz | KHz | ms | Range MHz | Band | Signal | Category |
| 1 | 3701 | 4385 | 684 | 0 | 0 | 1 | 300 | 836 | 4250-4350 | None | localized | A |
| 2 | 3850 | 4350 | 500 | −20 | 0 | 3 | 300 | 217 | 3850-4350 | yes | Broad | B |
| 3 | 3850 | 4350 | 500 | −20 | 0 | 3 | 300 | 217 | 3890-4350 | yes | Broad | B |
| 4 | 3850 | 4350 | 500 | −20 | 0 | 3 | 300 | 217 | 3890-4350 | yes | Broad | B |
| 5 and 6 | 3850 | 4350 | 500 | −20 | 0 | 3 | 300 | 217 | 3950-4350 | yes | Localized & | B |
| | | | | | | | | | | | Broad | |
| 7 and 8 | 3850 | 4350 | 500 | −20 | 0 | 3 | 300 | 217 | 3960-4350 | Yes | Localized & | B |
| | | | | | | | | | | | Broad | |
| 9 | 3704 | 4350 | 648 | 0 | 20 | 1 | 300 | 87 | 3704-4350 | yes | Broad | C |
| 10 | 3703 | 4350 | 647 | 0 | 20 | 1 | 300 | 83 | 3703-4350 | yes | Localized & | C |
| | | | | | | | | | | | Broad | |
| 11 and 12 | 4190 | 4400 | 210 | 0 | 0 | 1 | 300 | 67 | 4253-4338 | Band Pass | localized | A |
| | | | | | | | | | | Testing | | |
| 13 and 14 | 4189 | 4400 | 212 | 0 | 0 | 1 | 300 | 67 | 4253-4338 | Band Pass | localized | A |
| | | | | | | | | | | Testing | | |
| 15 | 4202 | 4380 | 178 | 0 | 20 | 1 | 300 | 67 | 4253-4338 | Band Pass | localized | A |
| | | | | | | | | | | Testing | | |
| 16 | 3850 | 4350 | 500 | 0 | 0 | 3 | 300 | 217 | 4250-4350 | None | localized | A |
| 17 | 3850 | 4350 | 500 | 0 | 0 | 3 | 300 | 217 | 3860-4350 | yes | Broad | B |
| 18 | 3850 | 4350 | 500 | 0 | 0 | 3 | 300 | 217 | 3850-4350 | yes | Broad | B |
| 19 | 3850 | 4350 | 500 | 0 | 0 | 3 | 300 | 217 | 3850-4350 | yes | Localized & | B |
| | | | | | | | | | | | Broad | |
| 20 | 3850 | 4350 | 500 | 0 | 0 | 3 | 300 | 217 | 3850-4350 | yes | Localized & | B |
| | | | | | | | | | | | Broad | |
| 21 | 3850 | 4350 | 500 | 0 | 0 | 3 | 300 | 217 | 3850-4350 | yes | Localized & | B |
| | | | | | | | | | | | Broad | |
| 22 | 3850 | 4350 | 500 | 0 | 0 | 3 | 300 | 217 | 3850-4350 | yes | Broad | B |
| 23 | 3850 | 4350 | 500 | 0 | 0 | 3 | 300 | 217 | 3850-4350 | yes | Broad | B |
| 24 | 3850 | 4350 | 500 | 0 | 0 | 3 | 300 | 217 | 3860-4350 | yes | Broad | B |
| 25 | 3850 | 4350 | 500 | 0 | 0 | 3 | 300 | 217 | 3850-4350 | Yes | Localized & | B |
| | | | | | | | | | | | Broad | |
| 26 | 3850 | 4350 | 500 | 0 | 0 | 3 | 300 | 217 | 3850-4350 | Yes | Broad | B |
| 27 | 3850 | 4350 | 500 | 0 | 0 | 3 | 300 | 217 | 3850-4350 | Yes | Broad | B |
| 28 | 3850 | 4350 | 500 | 0 | 0 | 3 | 300 | 217 | 3850-4350 | yes | Localized & | B |
| | | | | | | | | | | | Broad | |
| 29 | 3850 | 4400 | 500 | 0 | 0 | 1 | 300 | 87 | 3850-4350 | Yes | Localized & | B |
| | | | | | | | | | | | Broad | |
| 30 | 3100 | 4400 | 1300 | 0 | 20 | 1 | 300 | 133 | 4250-4350 | None | localized | A |
| 31 | 3108 | 4400 | 1278 | 0 | 20 | 1 | 300 | 135 | 3650-4350 | yes | Localized & | C |
| | | | | | | | | | | | Broad | |
| 32 | 3850 | 4350 | 500 | 0 | 0 | 3 | 300 | 217 | 4250-4350 | None | localized | A |
| 33 | 3850 | 4350 | 500 | 0 | 0 | 3 | 300 | 217 | 4150-4350 | yes | Broad | B |
| 34 | 3100 | 4400 | 1300 | 0 | 20 | 1 | 300 | 133 | 3550-4350 | yes | Localized & | C |
| | | | | | | | | | | | Broad | |

This data provided the basis to determine the optimum band pass frequencies to be utilized in conjunction with the presently disclosed systems and methods.

More specifically, the purpose of the band pass filter can be to detect interference, using a fast responding logarithmic power detector to create a voltage based on the output of the one or more band pass filters to alert the BBU coupled with the 5G C-band transmission site to attenuate the power of the transmission and/or alter the tilt of the transmission thereby allowing airplane safe landing even in low visibility airports under adverse conditions without unduly impacting the 5G coverage for the area.

In the table above, “A” categorized entries refer to airplane LRRA transmission with little or no detected out of band emission. Some of these transmissions generally tended to be in a range of about 4250-4385 MHz.

However, the “B” categorized entries include aircraft having LRRA transmission in their assigned band and in the adjacent 5G C-band. Some of these transmissions generally tended to be in a range of about 4250-4385 and about 4070-4190 MHz.

Finally, the “C” categorized entries include aircraft having LRRA transmission that are broad and extend out of the assigned LRRA band all the way into the adjacent 5G C-band, going as low as 3750 MHz.

Based on the experimental results obtained and described herein, a 120 MHz band pass region can be specifically selected to address signal to noise issues, such as the existence of a persistent yet variable noise floor. Likewise, in some configurations it was determined that a noise cancelation band pass filter having a pass band of about 4490-4610 MHz (120 MHz) may be utilized. In other configurations, a guard band of about 220 MHz past 4400, 4400-4620 MHz is considered to be the subject of future FCC auctions.

Although the above discussion has focused on LRRA and 5G C-band transmitter receivers, it will be understood that the methods and apparatuses discussed herein would be equally applicable to any set of transmitter/receiver combination having a first transmitter/receiver and a second transmitter/receiver,

### Example 4—Additional Circuit Configurations

Additional or alternate circuit configurations can be employed to detect interference without deviating from the scope of the present disclosure. Such alternate circuits can be employed in a standalone box or system (e.g., in a snooper box) or employed at a 5G station via a 5G Alarm Box or BBU or a combination of both. For instance, an alternative circuit configuration is shown in FIG. 11. As shown in FIG. 11, a suitable interference detection system 1100 may include an antenna 1101 which may be an antenna configured to receive signals in the band of about 4035-4135 MHz. The antenna may be a standalone antenna omnidirectional antenna or may be an existing 5G antenna. The antenna 1101 may be coupled with an amplifier 1102 such as a 20 dB ultra-low noise amplifier which is in turn coupled with one or more band pass filters through a low noise splitter 1103. The amplifier 1102 can be configured to amplify the received signal to ensure that the signal will meet the minimum threshold to be recognized by later components, such as the first and second band pass filters 1104a, 1104b which in some embodiments may have a minimum activation threshold of about −69 dB.

As shown in FIG. 11, the first band pass filter 1104a is configured to isolate a portion of the noise floor and has a band pass of about 4445-4555 MHz, while the second band pass filter 1104b is configured to isolate a portion of the received signal of interest and has a band pass of about 4035-4135 MHz to detect altimeter signals transmitted near the frequency allocated for the 5G C-band.

In the embodiment depicted in FIG. 11, each of the band pass filters 1104a, 1104b are coupled with an amplifier, such as the 20 dB ultra-low noise amplifiers 1105a, 1105b shown. In other embodiments, only one amplifier may be employed, or more than two may similarly be used. The amplifiers 1105a, 1105b are coupled with a chip or evaluation circuit 1106 such as an ADA 4625-1 chip which can be configured as a differential amplifier with low noise and high gain. This chip is typically not damaged by overvoltage and can be configured to obtain the difference of the two input voltages received from the two amplifiers 1105a, 1105b to detect the presence of a signal of interest over the persistent noise floor.

However, it will be appreciated that other configurations may be employed as well. For instance, in some embodiments only one series of amplifiers and band pass filters may be employed such that band pass filter 1104a, amplifier 1105a may be optional, with any remaining connections affixed to like components.

With continued reference to FIG. 11, the chip or evaluation circuit 1106 is coupled with a logarithmic power detector 1107 which can detect and convert the incoming power delivered in Watts to a voltage which can be detected by the interference detection voltage comparator 1108. In some embodiments, an inverter may be employed in association with the interference detection voltage comparator 1108 since an increase in the interference signal power level received may result in a decreased voltage level at voltage comparator due to, for instance, the choice of evaluation circuit or chip employed, the presence of an inverter elsewhere in the system, the use of a logarithmic power converter, or other factors. In turn, the interference detection voltage comparator 1108 can be configured to detect a difference in voltage outside a certain threshold, such as about 1.509 volts. In some configurations, the threshold value may be experimentally ascertained.

The interference detection voltage comparator 1108 can be coupled with a detection hold timer 1109 which can be used to prevent the system from oscillating between a ground state and a detection state by locking the system in a detection state for a certain threshold time upon an initial detection of a signal of interest. In some configurations, the threshold time may be about 2 minutes, but can be any value (e.g., in other embodiments it might be in the range of 2-10 minutes). In turn, the detection hold timer 1109 can be coupled with the 5G Alarm Box/BBU 1110 of the 5G station which can be used to employ an interference reduction technique and can also be coupled with a detection light 1111 to alert users of the interference detection status. To alert users to potential problems existing within the system, the logarithmic power detector 1107 may be coupled with a defect detection alarm voltage comparator 1112 which can compare the received voltage to a predefined voltage that indicates that a component within the system has failed. The defect detection alarm voltage comparator 1112 may compare the received voltage from the system to a threshold voltage and detect a voltage that is outside of the threshold. For instance, in some embodiments a minimum threshold of about 0.2 volts is used such that when any active component fails, detection of less than 0.2 volts would cause the system to alert the user. The defect detection alarm voltage comparator 1112 can communicate the existence of the problem to the 5G Alarm Box/BBU 1110 and may be coupled with a defect detection alarm light 1113 which can be illuminated to alert a user of a fault status within the system 1100.

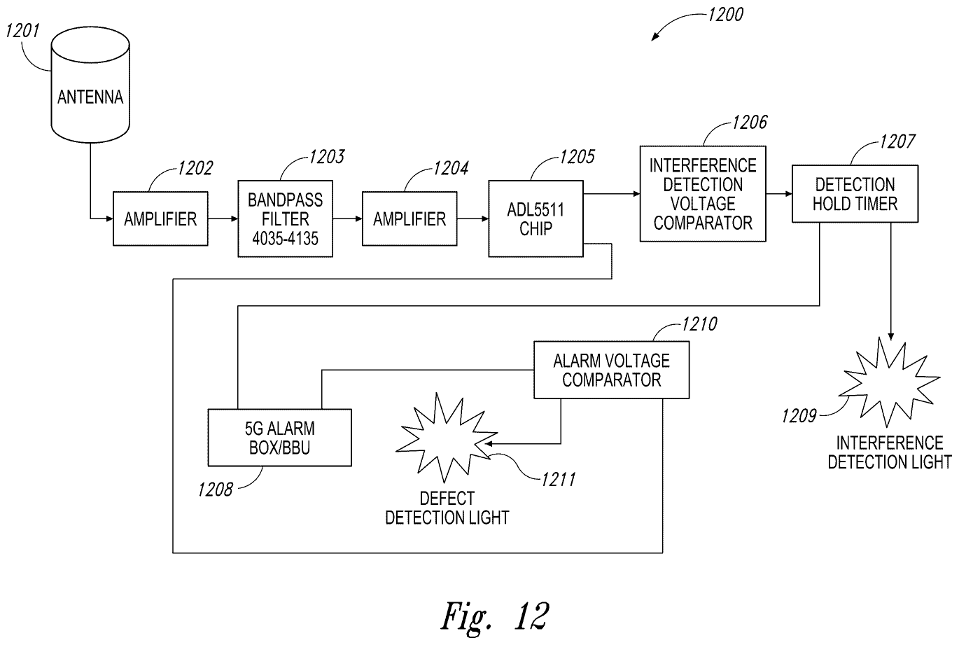

Another embodiment of a suitable system for detecting interference is shown in FIG. 12. As shown in FIG. 12, the system 1200 includes an antenna 1201. The antenna 1201 may be an omnidirectional antenna or an existing 5G antenna. The antenna 1201 can be configured to receive in a band of about 3900-4600 MHz, or about 4035-4135 MHz. The antenna 1201 is communicatively coupled with an amplifier 1202 such as a 20 dB ultra-low noise amplifier. The amplifier 1202 is communicatively coupled with a band pass filter 1203 configured to isolate a portion of the signal of interest in the passband of about 4035-4135 MHz. The band pass filter 1203 is communicatively coupled with an amplifier 1204 such as a 20 dB ultra-low noise amplifier. The amplifier 1204 feeds into an evaluation circuit or chip 1205, such as an ADL5511 chip configured to determine the root mean square (RMS) of the signal of interest. The evaluation circuit or chip 1205 is communicatively coupled with a detection voltage comparator 1206 configured to detect a change in voltage delivered by the evaluation circuit or chip. The detection voltage comparator 1206 may be coupled with a detection hold timer 1207 which can be used to prevent the system from oscillating between a ground state and a detection state by locking the system in a detection state for a certain threshold time upon an initial detection of a signal of interest. The detection hold timer 1207 may be coupled with the 5G Alarm Box/BBU 1208 of the 5G station which can be used to employ an interference reduction technique and can also be coupled with a detection light 1209 to alert users of the interference detection status. To alert users to potential problems existing within the system, evaluation circuit or chip 1205 may be coupled with a defect detection alarm voltage comparator 1210 which can compare the received voltage to a predefined voltage that indicates that a component within the system has failed and can communicate the existence of the problem to the 5G Alarm Box/5G BBU 1208. As such, the defect detection alarm voltage comparator 1210 may be coupled with a defect detection alarm light 1211 which can be illuminated to alert a user of a fault status within the system 1200.

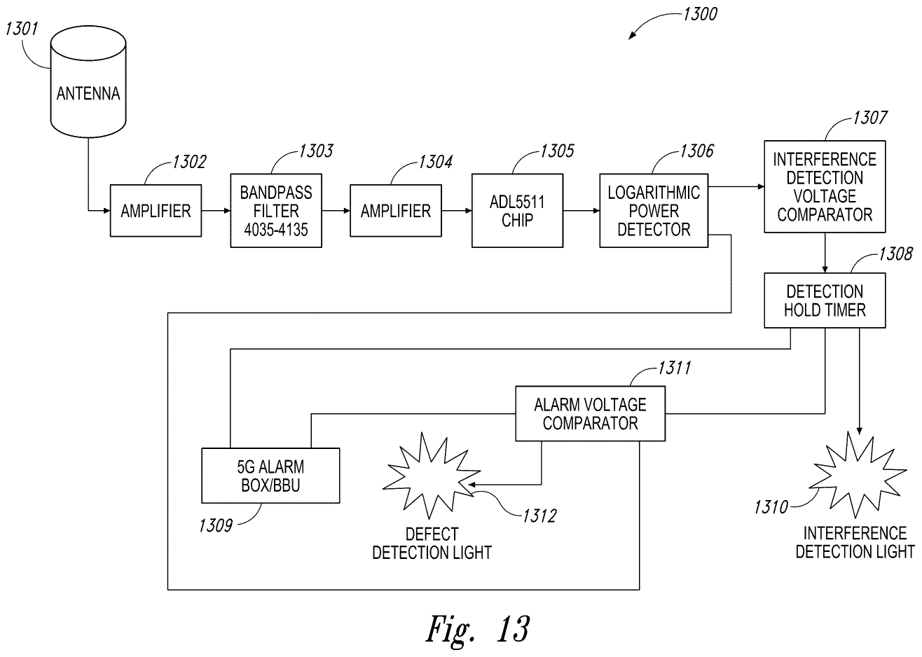

A further embodiment of an interference detection system is shown in FIG. 13. As shown in FIG. 13, the interference detection system 1300 includes an antenna 1301. The antenna 1301 may be an omnidirectional antenna or an existing 5G antenna configured to receive at least 4035-4135 MHz. The antenna 1301 is communicatively coupled with an amplifier 1302 such as a 20 dB ultra-low noise amplifier. The amplifier 1302 is communicatively coupled with a band pass filter 1303 configured to isolate a portion of the signal of interest in the passband of about 4035-4135 MHz. The band pass filter 1303 is communicatively coupled with an amplifier 1304 such as a 20 dB ultra-low noise amplifier. The amplifier 1304 feeds into an evaluation circuit or chip 1305, such as an ADL5511 chip configured to determine the frequency envelope of the signal of interest. The evaluation circuit or chip 1305 is communicatively coupled with a logarithmic power detector 1306. The logarithmic power detector 1306 is coupled with an interference detection voltage comparator 1307 having a preset threshold value, such as about 1.059. In some configurations, the threshold value may be experimentally ascertained.

The interference detection voltage comparator 1307 is coupled with a detection hold timer 1308 which is in turn coupled with the 5G Alarm Box/5G BBU 1309 and a detection light 1310 to alert users of the interference detection status. In some configurations, the detection hold timer 1308 is further coupled with the alarm voltage comparator 1311. In some embodiments, an inverter may be employed in association with the interference detection voltage comparator 1307 since an increase in the interference signal power level received may result in a decreased voltage level at voltage comparator due to, for instance, the choice of evaluation circuit or chip employed, the presence of an inverter elsewhere in the system, the use of a logarithmic power converter, or the like. Likewise, the logarithmic power detector 1306 may further be coupled with a defect detection alarm voltage comparator 1311 which can compare the received voltage to a predefined voltage that indicates that a component within the system has failed and can communicate the existence of the problem to the 5G Alarm Box/5G BBU 1309. The defect detection alarm voltage comparator 1311 may compare the received voltage from the system to a threshold voltage and detect a voltage that is outside of the threshold. For instance, in some embodiments a minimum threshold of about 0.2 volts is used such that when any active component fails, detection of less than 0.2 volts would cause the system to alert the user. For instance, the defect detection alarm voltage comparator 1311 may be coupled with a defect detection alarm light 1312 which can be illuminated to alert a user of a fault status within the system 1300.

### Example 5—Testing and Validation—Confusion Matrix

A confusion matrix is a tool that can be used to measure accuracy, precision, Recall, AUC-ROC, and other parameters of a system. Here, a confusion matrix may be employed to distinguish between various states shown in the table below.

TABLE 5

| | |
|---|---|
| True Positive | Interference Projected, |
| | Actual Interference |
| True Negative | No Interference Projected |
| | No Actual Interference |
| False Positive | Interference Projected |
| | No Actual Interference |
| False Negative | No Interference Projected |
| | Actual Interference |

Field testing can be performed to confirm that the system does not report false negative results, or only does so in exceedingly rare circumstances. Two testing regiments are presented below.

In a first configuration interactions between a 5G C-Band system and LRRA system can be tested at a relevant height having a detection system as disclosed herein with one or more omni antennae installed. At first, the 5G signal will be transmitted at or near the maximum possible power per radio (such as about 40 watts per radio) and maximum radio configurations (such as the number of radios per sector) and antennas (such as at least 3 sectors and 3 antennas total). A relevant height may be any height customarily achieved during take-off, landing, or general flight.

One or more aircraft with either an LRRA system susceptible to 5G interference installed, or a signal generator with an LRRA antenna may be employed. The transmit level of the LRRA would match that of the lowest power level per any original equipment manufacturer, which typically ranges from about 0.5 watts to about 5 watts.

The one or more aircraft would fly from 5 miles distance to the location of testing from two directions, such as the north and east directions to simulate and approach and landing. The worst-case scenario can be used for testing, such as the beginning of a runway at a low visibility airport. The threshold voltage value equivalent to 2 dBm will be set for 5 miles and 2500 feet altitude, 4 Miles and 2000 feet altitude, 3 Miles and 1500 feet altitude, 2 Miles 1000 feet altitude, and 1 mile and 700 feet altitude and 400 feet at the specified location, such as the start of the runaway. The collected data will help determine the accuracy and precision of the systems disclosed herein.

In a second configuration, can be performed substantially identical to the first. However, in this configuration, a receiver will also be placed inside the one or more aircraft in addition to transmit signal generator. This test allows one to predict interference or noninterference from the one or more aircraft, determine whether the prediction was correct, and to power down or tilt down the 5G transmission and see if the aircraft still receives any signal transmission that could cause receiver saturation of the LRRA.

### Example 6—Determination of Appropriate Thresholds

Testing was performed to determine how much amplification may be utilized by the system. In some configurations, too little amplification will result in the signal not being transmitted through the band pass filters, which in some embodiments, may have a minimum activation of about-69 dBm. On the other hand, too much amplification can result in the circuit failing to recognize the transmission or damaging the circuit.

In a first testing configuration, a HP8665A signal generator was utilized set at a frequency of about 4100 MHz in conjunction with one preamplifier to identify the amount of amplification needed to result in an adequate voltage threshold at the voltage comparator. Voltages equal to or exceeding this threshold will activate the detection light and signal the alarm box or BBU at the 5G station. The results are shown in the Table below, with an asterisk indicating where a major increase begins.

TABLE 6

| | dBm Level | V RMS | Venv. Detector |
|---|---|---|---|
| | HP8665 A | measured at | measured at Pwr detector |
| Run # | Transmit | ADA5911 | post Env detector |
| 1 | −100 | 0.034 | 1.432 |
| 2 | −90 | 0.036 | 1.41 |
| 3 | −85 | 0.041 | 1.377 |
| 4 | −80 | 0.052 | 1.338 |
| 5 | −75 | 0.078 | 1.267 |
| 6 | −70 | 0.128* | 1.188 |
| 7 | −65 | 0.215 | 1.116 |
| 8 | −60 | 0.373 | 1.027 |
| 9 | −55 | 0.607 | 0.894 |
| 10 | −50 | 0.615 | 0.796 |
| 11 | −45 | 0.617 | 0.74 |

A second test was conducted in a similar manner, and the results are depicted in the table below.

TABLE 7

| | Dbm Level | V RMS | Venv. Detector |
|---|---|---|---|
| | HP8665 A | measured at | measured at Pwr detector |
| Run # | Transmit | ADA5911 | post Env detector |
| 1 | −85 | 0.041 | 1.377 |
| 2 | −83 | 0.44 | 1.36 |
| 3 | −81 | 0.049 | 1.34 |
| 4 | −79 | 0.057 | 1.323 |
| 5 | −77 | 0.066 | 1.313 |
| 6 | −75 | 0.078 | 1.256 |
| 7 | −73 | 0.095 | 1.249 |
| 8 | −71 | 0.116 | 1.209 |
| 9 | −70 | 0.128 | 1.161 |
| 10 | −68 | 0.158 | 1.12 |
| 11 | −66 | 0.193 | 1.096 |
| 12 | −64 | 0.238 | 1.073 |
| 13 | −62 | 0.299 | 1.036 |
| 14 | −60 | 0.37 | 0.986 |
| 15 | −56 | 0.468 | 0.931 |
| 16 | −54 | 0.585 | 0.9 |
| 17 | −52 | 0.611 | 0.836 |
| 18 | | 0.613 | |

A third test was conducted with 10 dB of attenuation, and the results are depicted in the table below.

TABLE 8

| | | | V Env |
|---|---|---|---|
| RUN | dBm level at HO8665 A Transmit | V RMS | detector |
| 1 | −85 | 0.479 | 0.747 |
| 2 | −83 | 0.555 | 0.732 |
| 3 | −81 | 0.606 | |
| 4 | −79 | | |
| 5 | ABOVE THRESHOLD NO FUTHER | | |
| | TRESTING | | |

A fourth test was conducted with 1 amplifier before the band pass filter, 2 amplifiers after, and 20 dB of attenuation. The results are depicted in the table below.

TABLE 9

| | dBm Transmit at | | V Env |
|---|---|---|---|
| RUN | HP8665A | V RMS | Detector |
| 1 | −86 | 0.14 | 1.017 |
| 2 | −84 | 0.16 | 1 |
| 3 | −82 | 0.19 | 0.974 |
| 4 | −80 | 0.227 | 0.956 |
| 5 | −78 | 0.275 | 0.945 |
| 6 | −76 | 0.339 | 0.924 |
| 7 | −74 | 0.421 | 0.906 |
| 8 | −72 | 0.525 | 0.884 |
| 9 | −70 | 0.608 | 0.879 |
| 10 | −68 | 0.611 | 0.853 |
| 11 | −66 | 0.613 | 0.795 |
| 12 | −64 | 0.614 | 0.755 |
| 13 | −62 | 0.614 | 0.722 |
| 14 | −60 | 0.616 | 0.71 |
| 15 | −58 | 0.618 | 0.707 |
| 16 | −56 | 0.618 | 0.695 |
| 17 | −54 | | |

### CERTAIN TERMINOLOGY

The present disclosure provides a detailed description of various embodiments of systems and methods for reducing interference between two transmitter/receiver units. Although certain aspects, advantages, and features are described herein, it is not necessary that any particular embodiment include or achieve any or all of those aspects, advantages, or features. Some embodiments may not achieve the advantages described herein but may achieve other advantages instead. Any structure, material, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees,

It will also be understood that the term transmitter/receiver in different scenarios may include a transmitter, a receiver, or a transmitter and receiver.

Overall, the language of the claims is to be interpreted broadly based on the language employed in the claims. The claims are not to be limited to the non-exclusive embodiments and examples that are illustrated and described in this disclosure, or that are discussed during the prosecution of the application.

The following is claimed:

1. A method to estimate a magnitude a of signal received by a mobile transmitter-receiver unit from a stationary transmitter-receiver unit, the method comprising:
obtaining a signal emitted by the mobile transmitter-receiver unit at the stationary transmitter-receiver unit;
calculating an estimated pathloss of the obtained signal based on known parameters of the mobile transmitter-receiver unit;
estimating the proximity of the mobile transmitter-receiver unit from the stationary transmitter-receiver unit based on the calculated estimated pathloss; and
estimating the magnitude of the signal received by the mobile transmitter-receiver unit from the stationary transmitter-receiver unit based on known transmission parameters of the stationary transmitter-receiver unit.

2. The method of claim 1, wherein the first transmitter-receiver unit is an aircraft low range radio altimeter, and the second transmitter-receiver unit is a 5G transmission site.

3. The method of claim 2, wherein the signal emitted by the mobile transmitter-receiver unit is an aircraft low range radio altimeter transmission having a frequency ranging from about 3.7 GHz to about 4.5 GHz.

4. The method of claim 3, wherein detecting the aircraft low range radio altimeter transmission having a frequency ranging from about 3.7 GHz to about 4.5 GHz includes identifying the presence of at least one out of band emission ranging from about 4.035 GHz to about 4.135 GHz.

5. The method of claim 4, further comprising determining that the magnitude of the signal received at the mobile transmitter-receiver unit exceeds a certain threshold, and based on that determination, employing one or more interference reduction countermeasure, selected from the group consisting of:
reducing the transmission power of the stationary transmitter-receiver unit;
down tilting the transmission pattern of the stationary transmitter-receiver unit;
halting transmission at the stationary transmitter-receiver unit.

6. The method of claim 5, wherein determining that the magnitude of the signal received at the mobile transmitter-receiver unit exceeds a certain threshold includes estimating the pathloss of the received signal based on an estimated transmission power range for aircraft altimeters.

7. The method of claim 6, wherein reducing the power of the transmission of the second transmitter-receiver unit includes one or more iterative steps of:
attenuating the transmission power by 2 Watts; and
altering the angle at which the transmission of the second transmitter-receiver unit is emitted includes implementing a down tilt of about 3 degrees.

8. The method of claim 5, wherein halting the transmission at the second transmitter-receiver unit is applied after determining that attenuating the transmission power or altering the angle at which the transmission of the second transmitter-receiver unit is emitted cannot bring the interference level below the certain threshold based on the estimated proximity of the aircraft.

9. The method of claim 8, wherein the certain threshold is a 2 dBm signal.

10. The method of claim 9, further comprising determining a risk of interference by obtaining corroborating data from one or more datasets, the corroborating data including:
weather data;
visibility data;
runway condition data;
air traffic control data;
the aircraft identification information; and
past interference mitigation events.

11. The method of claim 10, wherein estimating the proximity of the mobile transmitter-receiver unit further includes:
further estimating the proximity of the mobile transmitter-receiver unit to the stationary transmitter-receiver unit based on the height, pitch, bank, and roll angles of the mobile transmitter-receiver unit and the aperture width of the mobile transmitter-receiver unit transmission cone.

12. A system for reducing interference between an aircraft low range radio altimeter and a 5G transmission site, the system comprising:
the 5G transmission site configured to include an antenna communicatively coupled with a power detector configured to identify the presence of an aircraft low range radio altimeter transmission;
a baseband unit communicatively coupled with the power meter, wherein the baseband unit is configured to control properties of the signal emitted from the 5G transmission site;
an operational support system, communicatively coupled with the baseband unit and configured to interface with one or more databases containing data relating to:
weather
visibility
runway conditions
air traffic; and
memory containing instructions corresponding to an algorithm that when executed by a processor cause the system to:
cause the baseband unit to employ one or more interference reduction techniques selected from:
reducing the power of the 5G transmission;
altering the angle at which the 5G transmission is emitted; and
halting the 5G transmission.

13. The system of claim 11, wherein the antenna is communicatively coupled with a 20 dB ultra-low noise amplifier communicatively coupled with a customized band pass filter having a passband of about 4035-4135 MHz; the customized band pass filter communicatively coupled with a 20 dB ultra-low noise amplifier which is in turn communicatively coupled with a root mean square detector communicatively coupled with a detection voltage comparator configured to identify the presence of an out of band LRRA emission.

14. The system of claim 12, wherein the algorithm further includes the step of determining that an interference level between the aircraft low range radio altimeter and the 5G transmission site exceeds a defined threshold by calculating the pathloss of the signal of interest based on the magnitude of the received aircraft low range radio altimeter transmission and using a known estimate for the transmission power of the low range radio altimeter transmission; and
measuring the magnitude of the received aircraft low range radio altimeter transmission;
calculating a path loss of the low range radio altimeter transmission based on the measured magnitude of the received signal and a known estimate for the transmission power of aircraft altimeters;
estimating the proximity of the aircraft based on the calculated pathloss of the signal;
calculating the pathloss of the 5G transmission based on the known transmission power and transmission angle of the 5G signal to estimate the magnitude of the 5G transmission received at the aircraft; and
determining that the magnitude of the 5G transmission received at the aircraft exceeds a defined threshold.

15. The system of claim 14, further comprising iteratively applying the one or more interference reduction techniques until the adjusted interference level no longer exceeds the defined threshold.

16. The system of claim 13, wherein the one or more interference reduction techniques are selected based upon the determined interference level between the aircraft radio altimeter and the 5G transmission site.

17. The system of claim 14, wherein:
the antenna is communicatively coupled with an amplifier configured to amplify at least a portion of the signal of interest;
the amplifier is communicatively coupled with a band pass filter;
the band pass filter is communicatively coupled with the power detector;
the power detector is communicatively coupled with a voltage comparator;
the voltage comparator is communicatively coupled with an alarm box associated with the 5G transmission site;
the alarm box is communicatively coupled with the base band unit.

18. The system of claim 17, wherein the band pass filter is configured with a passband of about 4500 MHz to about 4650 MHz.

19. A system configured to reduce interference between an aircraft low range radio altimeter and a 5G transmission site, the system comprising:
an antenna configured to receive signals having a frequency ranging from about 3.0 GHz to about 4.7 GHZ;
the antenna communicatively coupled with a splitter configured to split the received signal into two or more signals;
the splitter communicatively coupled with two or more amplifiers, the amplifiers configured to amplify the received and split signal;
the two or more amplifiers communicatively coupled with one or more band pass filters configured with distinct, non-overlapping passbands;
the two or more band pass filters configured with distinct, non-overlapping passbands are communicatively coupled with one or more fast reacting logarithmic power detectors;
the one or more fast reacting logarithmic power detectors communicatively coupled with at least one differential low noise amplifier configured to amplify the difference in voltage generated between the two or more band pass filters;
the at least one differential low noise amplifier communicatively coupled with at least one voltage comparator configured to identify the presence of a suspected low range radio altimeter signal based on the voltage difference generated by the differential low noise amplifier;
the at least one voltage comparator communicatively coupled with a base band unit disposed at the 5G transmission site;
the base band unit communicatively coupled with one or more operational support systems, the operational support systems configured to instruct the base band unit to employ one or more interference reduction countermeasures based on the detection of the suspected low range radio altimeter signal;
wherein the interference reduction countermeasures are selected from the group comprising:
reducing the power of the transmission of the second transmitter-receiver unit;
altering the angle at which the transmission of the second transmitter-receiver unit is emitted; and
halting the transmission at the second transmitter-receiver unit.

20. The system of claim 19, wherein the two band pass filters are configured to cancel a persistent but variable noise floor having a frequency ranging from about 4.5 GHz to about 4.65 GHz, and a magnitude of about −80 dBm.
